(19) United States
(12) Patent Application Publication
(10) Pub. No.: US 2008/0309772 A1
(43) Pub. Date: Dec. 18, 2008

(54) IMAGE PICKUP APPARATUS AND METHOD, LENS UNIT AND COMPUTER EXECUTABLE PROGRAM

(75) Inventor: Kouichi Ikeda, Miyagi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/123,854

(22) Filed: May 20, 2008

(30) Foreign Application Priority Data
Jun. 14, 2007 (JP) 2007-157635

(51) Int. Cl. H04N 5/228; G03B 17/00

(52) U.S. Cl. 348/208.7; 396/55; 348/E05.031

(57) ABSTRACT

A digital still camera includes a lens system having a variable focal length. An image pickup unit is disposed on an optical axis of the lens system, for forming an image frame. Yaw and pitch rate sensors detect a camera shake to output shake information. A shake correction mechanism, associated with an anti-vibration lens, compensates for the camera shake by shifting perpendicularly to the optical axis according to the shake information. A memory stores an LUT of correlation information between the focal length and a shift amount of the shake correction mechanism to compensate for an image shake of the image frame created due to a change in the focal length. In case of lack of detected camera shake with the yaw and pitch rate sensors, the shake correction mechanism is controlled with a shift amount associated with the focal length according to the LUT.

### BACKGROUND OF THE INVENTION

1. Field of the Invention

The present invention relates to an image pickup apparatus and method, lens unit and computer executable program. More particularly, the present invention relates to an image pickup apparatus and method in which a shake correction device for correction of a camera shake is incorporated, and also image quality can be kept high even when a lens system is zoomed, and a lens unit and computer executable program.

2. Description Related to the Prior Art

A digital still camera is an optical instrument including an image pickup unit or CCD image sensor for recording image data of an image picked up by use of a memory card or the like. There is a problem of a camera shake typically when a user's hand vibrates the digital still camera in depression of a shutter release button or the like, to lower the image quality in an image frame. Thus, a new type of the digital still camera known in the art has a shake correction device to eliminate influence of a shake from the image frame.

The digital still camera with the shake correction device includes a lens unit having a lens system in a lens barrel, an angular velocity sensor, an anti-vibration lens/lens group included in the lens system, and a shake correction mechanism for shifting the anti-vibration lens/lens group in directions perpendicular to the optical axis. An angular velocity of a shake is detected by the angular velocity sensor. The anti-vibration lens/lens group is driven by the shake correction mechanism according to an angle of the shake determined on the basis of the angular velocity. A light path of the lens system is deflected to stabilize an image. Also, a shake correction type of the digital still camera in which the image pickup unit is shiftable in directions perpendicular to the optical axis is known in the art.

JP-A 6-160693 and JP-A 7-027965 disclose a lens assembly to solve the problem in difficult handling due to the considerably great change in the angle of view upon small rotation of the zoom ring. In the lens assembly of the documents, two or more computer programs are stored for changes in the focal length of the lens system according to a rotating amount and rotational direction of the zoom ring, to change over the programs automatically according to the operation state of the zoom ring.

Also, U.S. Pat. No. 6,785,426 (corresponding to JP-A 2001-223942) discloses the digital still camera in which the shake correction device is utilized to form a panoramic image frame by combining plural images.

There is a phenomenon of shifting a position of an image in an electronic viewfinder of the digital still camera in the course of zooming the lens system no matter how firmly the digital still camera is positioned on a tripod or the like. The problem of the image shifting is supposed to occur due to a difference between the center of a reception surface of the image pickup unit and the optical axis of the lens system during the manufacture. However, the center difference is in a extremely small size, for examples several microns. To eliminate the center difference completely is not practical, because it will require too high an expense for the adjustment and will result in low yield in view of the productivity. A user having the digital still camera with the lens system is still obliged to frame an object each time that the lens system is zoomed. Also, if the digital still camera is used as a monitor camera, an object framed inside the image frame may be missed outside the image frame incidentally when the lens system is zoomed.

### SUMMARY OF THE INVENTION

In view of the foregoing problems, an object of the present invention is to provide an image pickup apparatus and method in which a shake correction device for correction of a camera shake is incorporated, and also image quality can be kept high even when a lens system is zoomed, and a lens unit and computer executable program.

In order to achieve the above and other objects and advantages of this invention, an image pickup apparatus includes a lens system having a variable focal length. An image pickup unit is disposed on an optical axis of the lens system, for image pickup of an image frame. A shake detector detects a camera shake to output shake information. There is an anti-vibration element for shake correction of the camera shake. A shake correction mechanism drives to shift the anti-vibration element on a plane perpendicular to the optical axis. A memory stores information of a shift amount of the anti-vibration element in correlation with the focal length, to compensate for an image shake in the image frame due to a change in the focal length. A controller controls the shake correction mechanism according to the shake information to compensate for the camera shake, and in case of lack of compensation for the camera shake, controls the shake correction mechanism according to the information read from the memory to compensate for the image shake.

In one aspect of the invention, image pickup apparatus includes a lens system having a variable focal length. An image pickup unit is disposed on an optical axis of the lens system, for image pickup of an image frame. A shake detector detects a camera shake to output shake information. There is an anti-vibration element for shake correction of the camera shake. A shake correction mechanism drives to shift the anti-vibration element on a plane perpendicular to the optical axis. A memory stores position information of the anti-vibration element in correlation with the focal length, to minimize influence of lens aberration changeable according to a change in the focal length. A controller controls the shake correction mechanism according to the shake information to compensate for the camera shake, and in case of lack of compensation for the camera shake, controls the shake correction mechanism according to the information read from the memory, to minimize influence of the lens aberration.

In another aspect of the invention, image pickup apparatus includes a lens system having a variable focal length. An image pickup unit is disposed on an optical axis of the lens system, for image pickup of an image frame. A shake detector detects a camera shake to output shake information. There is an anti-vibration element for shake correction of the camera shake. A shake correction mechanism drives to shift the anti-vibration element on a plane perpendicular to the optical axis. An object detection unit detects an object region of a principal object in the image frame. A checker determines a position of the principal object in the image frame. A controller controls the shake correction mechanism according to the shake information to compensate for the camera shake, and in case of lack of compensation for the camera shake, controls the shake correction mechanism according to the position of the principal object to set the object region nearer to a middle of the image frame.

In one aspect of the invention, image pickup apparatus includes a lens system having a variable focal length. An image pickup unit is disposed on an optical axis of the lens system, for image pickup of an image frame. A shake detector detects a camera shake to output shake information. There is an anti-vibration element for shake correction of the camera shake. A shake correction mechanism drives to shift the anti-vibration element on a plane perpendicular to the optical axis. A controller controls the shake correction mechanism according to the shake information to compensate for the camera shake, and in case of lack of compensation for the camera shake, drives the image pickup unit in controlling the shake correction mechanism to shift the anti-vibration element two-dimensionally in order to form plural image frames consecutively. An image synthesis unit obtains a composite image frame in a larger size than the image frame by image synthesis of the plural image frames.

Preferably, the image synthesis unit combines middle portions of the plural image frames to obtain the composite image frame.

The anti-vibration element shifts on an orbit in a quadrilateral shape defined around a center at the optical axis in consecutive imaging.

The anti-vibration element is a selected one of an anti-vibration lens included in the lens system and the image pickup unit.

Also, a lens unit is provided, and includes a lens system having a variable focal length. A shake detector detects a camera shake to output shake information. A shake correction device compensates for the camera shake by shifting on a plane being perpendicular to an optical axis of the lens system according to the shake information. A memory stores correlation information between the focal length and a shift amount of the shake correction device to compensate for an image shake of an image frame created due to a change in the focal length. A controller is responsive in case of lack of detected camera shake with the shake detector, for controlling the shake correction device with a shift amount associated with the focal length according to the correlation information.

Also, an image pickup method of picking up an image frame with an image pickup unit disposed on an optical axis through a lens system having a variable focal length is provided. The image pickup method includes detecting a camera shake with a shake detector, to output shake information. The camera shake is compensated for by shifting a shake correction device on a plane being perpendicular to the optical axis according to the shake information. Correlation information is predetermined between the focal length and a shift amount of the shake correction device to compensate for an image shake of the image frame created due to a change in the focal length. In case of lack of detected camera shake with the shake detector, the shake correction device is controlled with a shift amount associated with the focal length according to the correlation information.

In one preferred embodiment, position information of the shake correction device to minimize influence of lens aberration of the lens system to the image frame is further predetermined in association with the focal length. In case of lack of detected camera shake with the shake detector, the position information is retrieved according to the focal length, to control the shake correction device.

In another preferred embodiment, furthermore, a focus lens included in the lens system is moved to focus an object. It is checked whether an object region of the object in the image frame is in a middle of the image frame. In case of lack of detected camera shake with the shake correction device and if the object region is offset from the middle of the image frame, the shake correction device is controlled to set the object region nearer to the middle.

In one preferred embodiment, furthermore, in case of lack of detected camera shake with the shake detector, the shake correction device is shifted to plural positions in a consecutive sequence, to form plural image frames by picking up an object with the image pickup unit when the shake correction device is set in each of the plural positions. A composite image frame is obtained in a larger size than the image frame by image synthesis of the plural image frames.

In still another preferred embodiment, furthermore, in case of lack of detected camera shake with the shake detector, the shake correction device is shifted to plural positions in a consecutive sequence, to form plural image frames by picking up an object with the image pickup unit when the shake correction device is set in each of the plural positions. One composite image frame is obtained by image synthesis of middle portions of the plural image frames being formed.

The shake correction device shifts one of the image pickup unit and an anti-vibration lens included in the lens system on the plane being perpendicular to the optical axis.

Also, a computer executable program for control of an image pickup apparatus is provided, the image pickup apparatus including a lens system having a variable focal length, and an image pickup unit, disposed on an optical axis of the lens system, for forming an image frame. The computer executable program includes a detecting program code for detecting a camera shake with a shake detector, to output shake information. A correcting program code is for compensating for the camera shake by shifting a shake correction device on a plane being perpendicular to the optical axis according to the shake information. Correlation information is predetermined between the focal length and a shift amount of the shake correction device to compensate for an image shake of the image frame created due to a change in the focal length. A control program code is for, in case of lack of detected camera shake with the shake detector, controlling the shake correction device with a shift amount associated with the focal length according to the correlation information.

In one preferred embodiment, position information of the shake correction device to minimize influence of lens aberration of the lens system to the image frame is further predetermined in association with the focal length. Furthermore, there is a program code for, in case of lack of detected camera shake with the shake detector, retrieving the position information according to the focal length, to control the shake correction device.

In another preferred embodiment, furthermore, there is a focusing program code for moving a focus lens included in the lens system, to focus an object. A checking program code is for checking whether an object region of the object in the image frame is in a middle of the image frame. A control program code is for, in case of lack of detected camera shake with the shake correction device and if the object region is offset from the middle of the image frame, controlling the shake correction device to set the object region nearer to the middle.

In one preferred embodiment, furthermore, a consecutive imaging program code for, in case of lack of detected camera shake with the shake detector, shifting the shake correction device to plural positions in a consecutive sequence, to form plural image frames by picking up an object with the image pickup unit when the shake correction device is set in each of the plural positions. An image synthesis program code is for obtaining a composite image frame in a larger size than the image frame by image synthesis of the plural image frames.

In still another preferred embodiment, furthermore, there is a consecutive imaging program code for, in case of lack of detected camera shake with the shake detector, shifting the shake correction device to plural positions in a consecutive sequence, to form plural image frames by picking up an object with the image pickup unit when the shake correction device is set in each of the plural positions. An image synthesis program code is for obtaining one composite image frame by image synthesis of middle portions of the plural image frames being formed.

Also, a user interface for control of an image pickup apparatus is provided, the image pickup apparatus including a lens system having a variable focal length, and an image pickup unit, disposed on an optical axis of the lens system, for forming an image frame. The user interface includes a detecting region for detecting a camera shake with a shake detector, to output shake information. A correcting region is for compensating for the camera shake by shifting a shake correction device on a plane being perpendicular to the optical axis according to the shake information. Correlation information is predetermined between the focal length and a shift amount of the shake correction device to compensate for an image shake of the image frame created due to a change in the focal length. A control region is for, in case of lack of detected camera shake with the shake detector, controlling the shake correction device with a shift amount associated with the focal length according to the correlation information.

Consequently, image quality can be kept high even when a lens system is zoomed, because the shake correction device can be driven according to a shift amount determined in consideration of correlation with the focal length.

### BRIEF DESCRIPTION OF THE DRAWINGS

The above objects and advantages of the present invention will become more apparent from the following detailed description when read in connection with the accompanying drawings, in which:

FIG. 1 is a perspective view illustrating a digital still camera;

FIG. 2 is a rear perspective view illustrating the digital still camera;

FIG. 3 is a block diagram schematically illustrating the digital still camera;

FIG. 4 is a block diagram schematically illustrating a shake correction device;

FIG. 5 is a flow chart illustrating a sequence of image pickup of a chart;

FIG. 6 is an explanatory view in elevation illustrating the image pickup of the chart;

FIG. 7 is a plan illustrating a shift of a live image on a display panel;

FIG. 8 is a graph illustrating correlation between voltage and a position of an anti-vibration lens;

FIG. 9 is a flow chart illustrating a sequence of image pickup;

FIG. 10 is a flow chart illustrating one preferred sequence of image pickup of a light box;

FIG. 11 is an explanatory view in elevation illustrating the image pickup of the light box;

FIGS. 12A, 12B and 12C are graphs illustrating shading of zoom positions;

FIG. 13 is a table illustrating movement of the anti-vibration lens in the image pickup of the light box;

FIG. 14 is a flow chart illustrating a sequence of image pickup;

FIG. 15 is a block diagram schematically illustrating another preferred digital still camera;

FIGS. 16A, 16B and 16C are plans illustrating displayed and recorded image frames;

FIG. 17 is a flow chart illustrating a sequence of image pickup;

FIG. 18 is an explanatory view illustrating another preferred image synthesis;

FIG. 19 is a flow chart illustrating a sequence of a large size mode of image pickup;

FIG. 20 is an explanatory view in elevation illustrating a state of shifting the anti-vibration lens in an upward direction;

FIG. 21 is an explanatory view illustrating the image synthesis with removal of an overlapped portion;

FIG. 22 is an explanatory view illustrating still another preferred image synthesis;

FIGS. 23A, 23B, 23C and 23D are graphs illustrating removal of shading;

FIG. 24 is a flow chart illustrating a sequence of a survey mode;

FIG. 25A, 25B, 25C and 26C are plans illustrating surveying of an object;

FIG. 26 is a block diagram schematically illustrating another preferred lens unit.

### DETAILED DESCRIPTION OF THE PREFERRED EMBODIMENT(S) OF THE PRESENT INVENTION

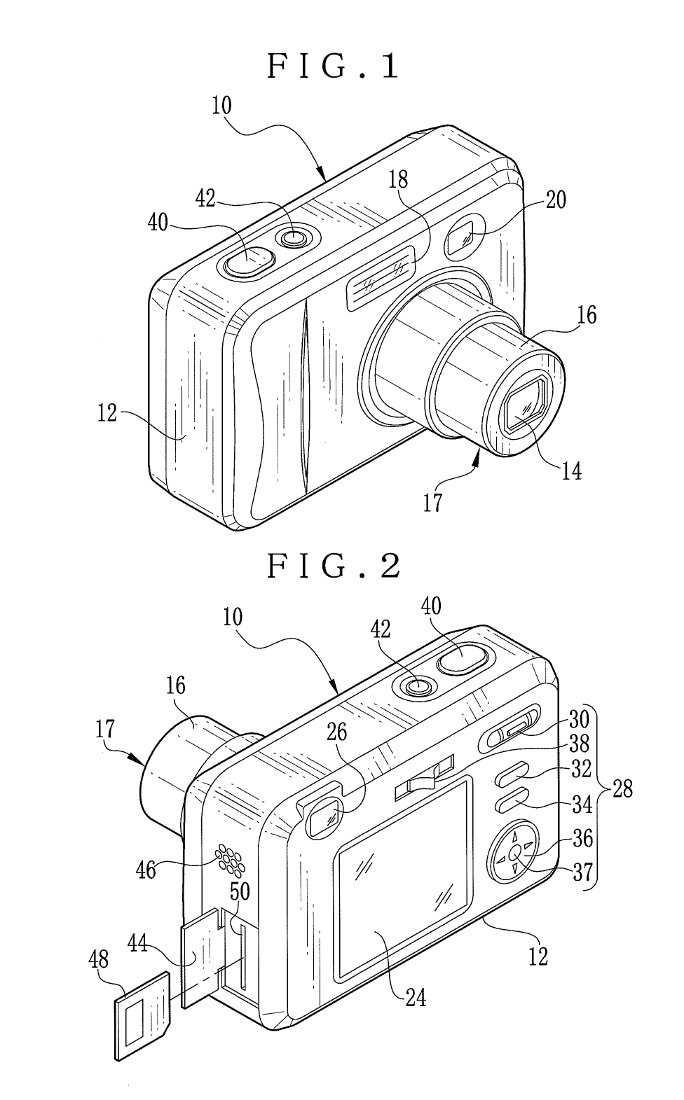

In FIG. 1, a digital still camera 10 of the invention has a camera body 12. A front surface of the camera body 12 has a lens unit 17 or lens assembly, a flash light source 18, and a viewfinder objective window 20. The lens unit 17 includes a lens barrel 16 and a zoom lens system 14 incorporated in the lens barrel 16.

The lens barrel 16, in the digital still camera 10 of the collapsible type, is movable between a front position of FIG. 1 and a rear position (not shown), and when in the front position, projects from the camera body 12 for use, and when in the rear position, is contained in the camera body 12 at the time of no use. The flash light source 18 applies flash light to an object in a scene according to object brightness. The viewfinder objective window 20 is included in an optical viewfinder.

In FIG. 2, a rear surface of the camera body 12 has an LCD display panel 24, a viewfinder eyepiece window 26 of the optical viewfinder, and a button panel 28. The LCD display panel 24 displays a live image, a playback image and patterns of menu screens.

The button panel 28 includes a zoom button 30, a menu button 32, a changeover button 34, a cross shaped key 36, a confirmation key 37, and a mode button 38. The zoom button 30 is operable to move a variator lens/lens group in the lens system 14 in directions toward the telephoto and wide-angle end positions. The menu button 32 is operated for causing the LCD display panel 24 to display a menu screen and to confirm a selected item on the menu screen. The changeover button 34 is operated to change over the items on the menu screen.

The cross shaped key 36 is operable for shifting a cursor in the menu screen. The confirmation key 37 is operable for confirming an input signal. The mode button 38 is operable to change over the operation modes of the digital still camera 10. Examples of the operation modes include an image mode for image pickup of a still image, a playback mode for playing back an image on the LCD display panel 24, a large size mode for image pickup at a large size, and a location survey mode.

A shutter release button 40 and a power switch 42 are disposed on an upper surface of the camera body 12. The shutter release button 40 is a two-step switch. When the shutter release button 40 is depressed halfway, steps to stand by for image pickup are carried out. When the shutter release button 40 is depressed fully, an image is picked up for recording. The power switch 42 is operated to turn on and off the power source of the digital still camera 10.

A lateral surface of the camera body 12 has an openable card slot lid 44 and a sound source 46. A card slot 50 is covered by the slot lid 44 openably. A memory card 48 is insertable in the card slot 50 when the slot lid 44 is open. The sound source 46 as speaker emits a shutter sound when the shutter release button 40 is depressed fully.

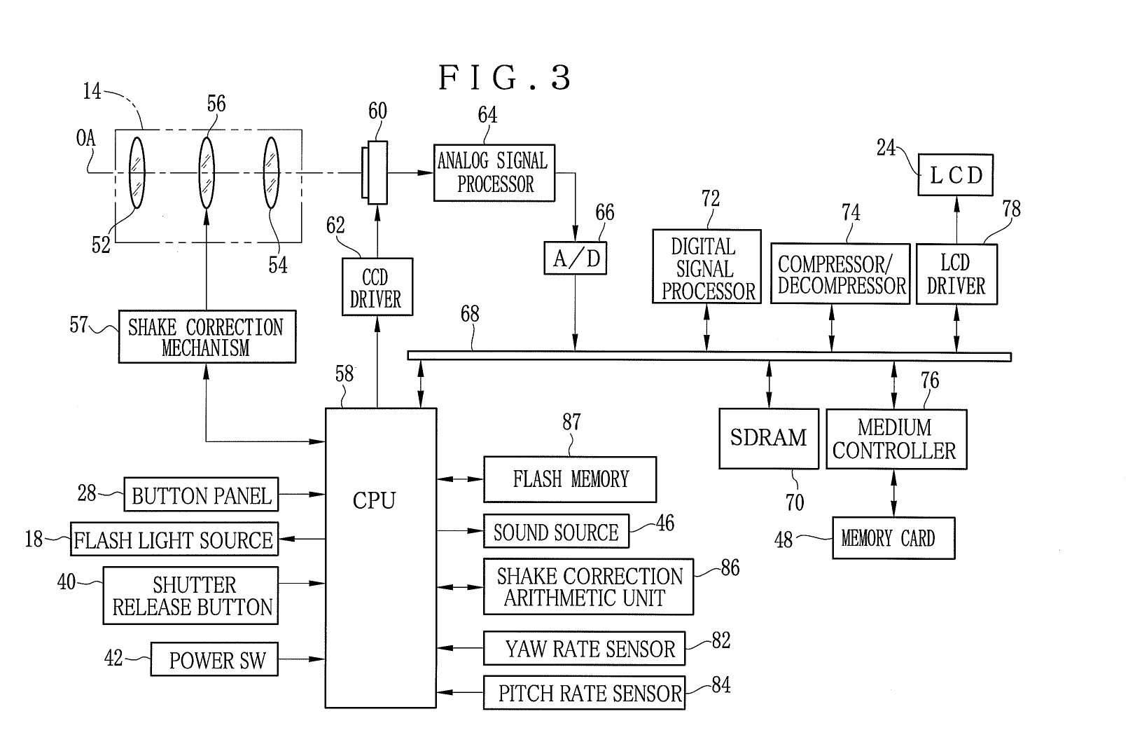

In FIG. 3, the lens system 14 includes a variator lens/lens group 52, a focus lens/lens group 54, and an anti-vibration lens/lens group 56. When the zoom button 30 of FIG. 2 is operated, the variator lens/lens group 52 is caused by a zoom mechanism to move stepwise toward the telephoto or wide-angle end position. When the variator lens/lens group 52 is moved or the shutter release button 40 is depressed halfway, the focus lens/lens group 54 is moved and set in an in-focus lens position by an autofocus mechanism (not shown).

A shake correction mechanism 57 or image stabilization keeps the anti-vibration lens/lens group 56 shiftable in direction in a plane perpendicular to the optical axis OA of the lens system 14. The anti-vibration lens/lens group 56 compensates for a shake of an image frame due to a camera shake, and also for a shift of an image frame changeable according to moving of the variator lens/lens group 52 for zooming. A CPU 58 controls operation of the zoom mechanism, focusing mechanism and the shake correction mechanism 57.

An image pickup unit or CCD 60 is disposed behind the lens system 14 for picking up an object image. A CCD driver 62 is controlled by the CPU 58 and drives the image pickup unit 60. The CCD driver 62 supplies the image pickup unit 60 with a timing signal or clock pulse for controlling time of storing charge and a time point of removing charge in the image pickup unit 60.

An analog signal processor 64 is supplied with an image signal output by the image pickup unit 60. The analog signal processor 64 processes the image signal in correlation double sampling, and outputs R, G and B image signals exactly corresponding to the amount of the stored charge of cells in the image pickup unit 60. The analog signal processor 64 amplifies the image signals with a predetermined factor of amplification. An A/D converter 66 is supplied with the amplified image signals.

The A/D converter 66 outputs CCD-RAW data as digital image data by conversion of the image signal into a digital form. A data bus 68 is connected with the A/D converter 66. An SDRAM 70 is supplied with the CCD-RAW data from the A/D converter 66 through the data bus 68, and stores the data. A timing generator (not shown) sends a timing signal to the analog signal processor 64 and the A/D converter 66, which are driven in synchronism. CCD-RAW data are output at a constant frame rate.

A digital signal processor 72 reads CCD-RAW data from the SDRAM 70, and processes the same in the white balance correction, gamma correction and the like. Image data obtained after processing in the digital signal processor 72 is written to the SDRAM 70 again.

A compressor/decompressor 74 compresses image data read from the SDRAM 70 in a predetermined file format, for example JPEG format (Joint Picture Experts Group). An image file obtained by the compression in the compressor/decompressor 74 is written to the SDRAM 70. In the playback mode, the compressor/decompressor 74 decompresses the image file. A medium controller 76 controls writing and reading of image data or image file in relation to the memory card 48.

An LCD driver 78 is connected with a VRAM (not shown) for storing CCD-RAW data of two frames read from the SDRAM 70. Reading of CCD-RAW data to the VRAM is simultaneous with writing to the same. The LCD driver 78 converts the CCD-RAW data read from the VRAM into a composite signal of an analog form, and drives the LCD display panel 24 to display a live image according to the composite signal. Also, the LCD driver 78 causes the LCD display panel 24 to display a playback image according to the decompressed image data from the medium controller 76.

The CPU 58 sends a control signal to elements in the digital still camera 10, and also receives a response signal from those elements, to control the operation of the digital still camera 10. The CPU 58 causes various elements to operate to stand by for image pickup, and to pick up an image in response to a command signal input by the shutter release button 40 in the halfway depression and full depression. The CPU 58 causes various elements to operate in response to a command signal input by the button panel 28.

When the shutter release button 40 is depressed fully, an image is picked up. Should a camera shake occur in the image pickup, an object image becomes shifted on a reception surface of the image pickup unit 60 within one frame. An image signal of an image with the shake is output by the image pickup unit 60. To compensate for a camera shake, there are a yaw rate sensor 82, a pitch rate sensor 84 and a shake correction arithmetic unit 86 or shake stabilizer are connected with the CPU 58 in combination with the shake correction mechanism 57.

A flash memory 87 is connected with the CPU 58. The flash memory 87 stores a lookup table and a control program. The lookup table is a data table of correlation of the shift information, which will be described later. According to the control program, the CPU 58 refers to the lookup table, sends a command signal to a VCM control unit, and controls a driving circuit for shake correction or image stabilization.

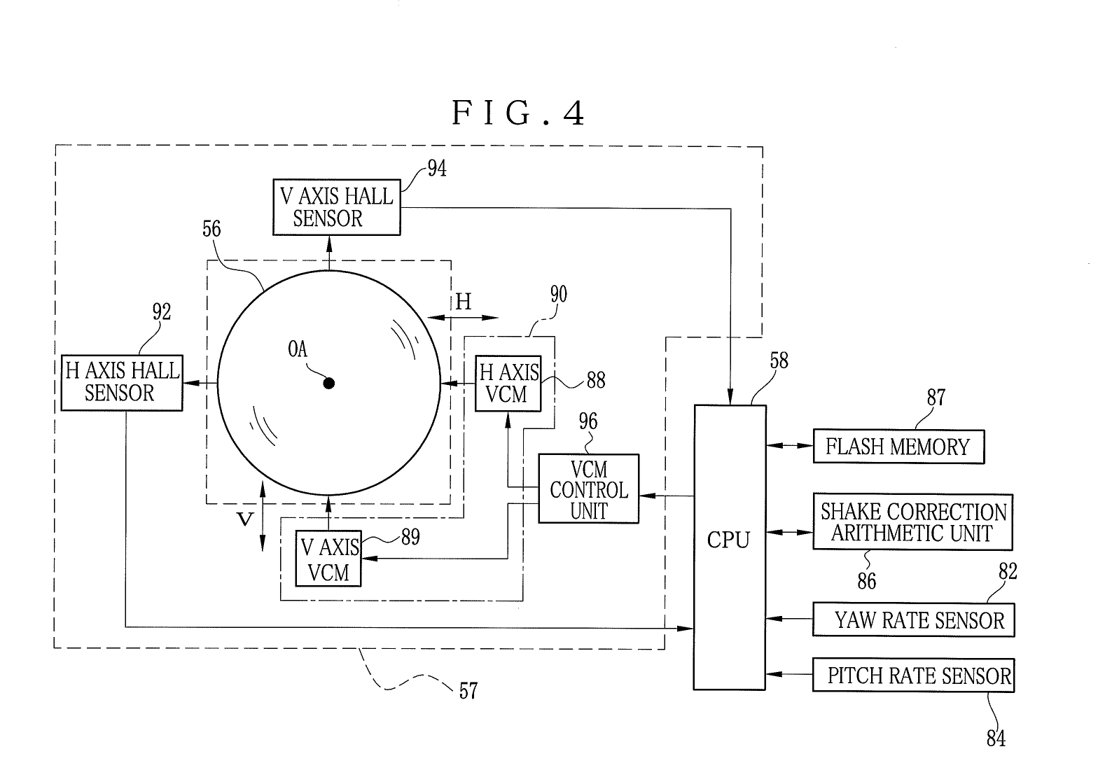

In FIG. 4, the shake correction mechanism 57 includes a shake correction shifter 90 for shake correction or image stabilization, an H axis Hall sensor 92, a V axis Hall sensor 94 and a VCM control unit 96. The shake correction shifter 90 includes an H axis VCM 88 (voice coil motor) and a V axis VCM 89 (voice coil motor). In the drawing, elements additional to important circuits or mechanisms are omitted for the purpose of simplicity.

The H and V axis VCMs 88 and 89 are linear motors constituted respectively by a voice coil or movable winding and a permanent magnet. The H and V axis VCMs 88 and 89 have such a rapid response that a flow of a current causes the voice coil to move linearly in the magnetic field of the permanent magnet. The H axis VCM 88 shifts the anti-vibration lens 56 in the H direction. The V axis VCM 89 shifts the anti-vibration lens 56 in the V direction. The anti-vibration lens 56 is kept shiftable in a plane vertical to the optical axis OA by the H and V axis VCMs 88 and 89.

The H axis Hall sensor 92 detects a position of the anti-vibration lens 56 in the H direction. The V axis Hall sensor 94 detects a position of the anti-vibration lens 56 in the V direction. A location of the anti-vibration lens 56 within the lens barrel 16 can be determined according to output of the H and V axis Hall sensors 92 and 94.

The yaw and pitch rate sensors 82 and 84 or gyro sensors as shake detector are secured to the camera body 12 fixedly in suitable positions. The yaw rate sensor 82 detects an angular velocity of a shake of the digital still camera 10 in the yaw direction, and inputs data of the angular velocity to the CPU 58. Also, the pitch rate sensor 84 detects an angular velocity of a shake of the digital still camera 10 in the pitch direction, and inputs data of the angular velocity to the CPU 58.

The shake correction arithmetic unit 86 processes an angular velocity signal from the yaw and pitch rate sensors 82 and 84 by A/D conversion, integration and other processing. Angles of a shake of the digital still camera 10 in the yaw direction and pitch direction are calculated. Then the shake correction arithmetic unit 86 determines a shift amount for correction according to the angle data of the camera body 12 in the yaw and pitch directions and position data of the anti-vibration lens 56 detected by the H and V axis Hall sensors 92 and 94, so as to correct a shake of an image frame by shifting the anti-vibration lens 56 in the H and V directions.

The yaw and pitch rate sensors 82 and 84 and the H and V axis Hall sensors 92 and 94 are driven at a frequency of 10-20 Hz. The shake correction arithmetic unit 86 determines data of a shift amount for correcting shake according to the shake angle data and position data obtained newly by the yaw and pitch rate sensors 82 and 84 and the H and V axis Hall sensors 92 and 94. The data of the shift amounts for correcting shake are input to the CPU 58.

The VCM control unit 96 controls the H and V axis VCMs 88 and 89 in response to a command signal from the CPU 58. The VCM control unit 96 operates according to data of a shift amount for shake correction or image stabilization in the H and V directions, and inputs excitation current to the H and V axis VCMs 88 and 89. Thus, the anti-vibration lens 56 is shifted in the H and V directions according to the determined shift amount for the shake correction, and corrects a shake of an image frame.

The anti-vibration lens 56 compensates for a camera shake, and also for blur of an image frame changeable according to moving or zooming of the variator lens/lens group 52. Details of this are described now. An optical axis OA of the lens system 14 should be exactly perpendicular to a reception surface of the image pickup unit 60 and should pass through the center of the reception surface. However, an error is likely to occur with the optical axis OA according to fine differences in the manufacture. The center of an image focused on the reception surface of the image pickup unit 60 by the lens system 14 may be offset from the center of the reception surface. A shift is likely to occur between an image frame recorded on the telephoto side and such recorded on the wide-angle side.

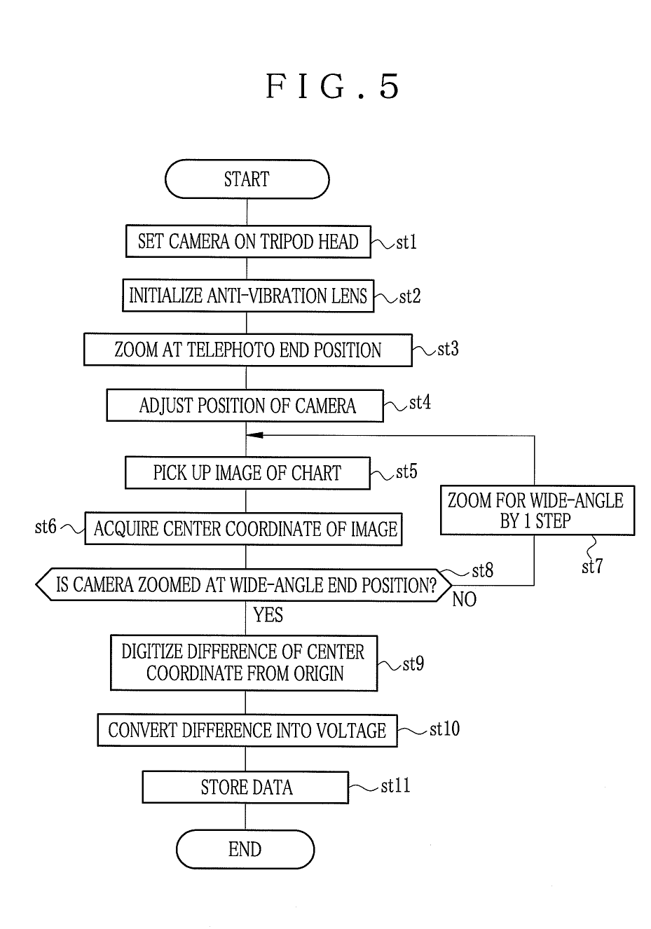

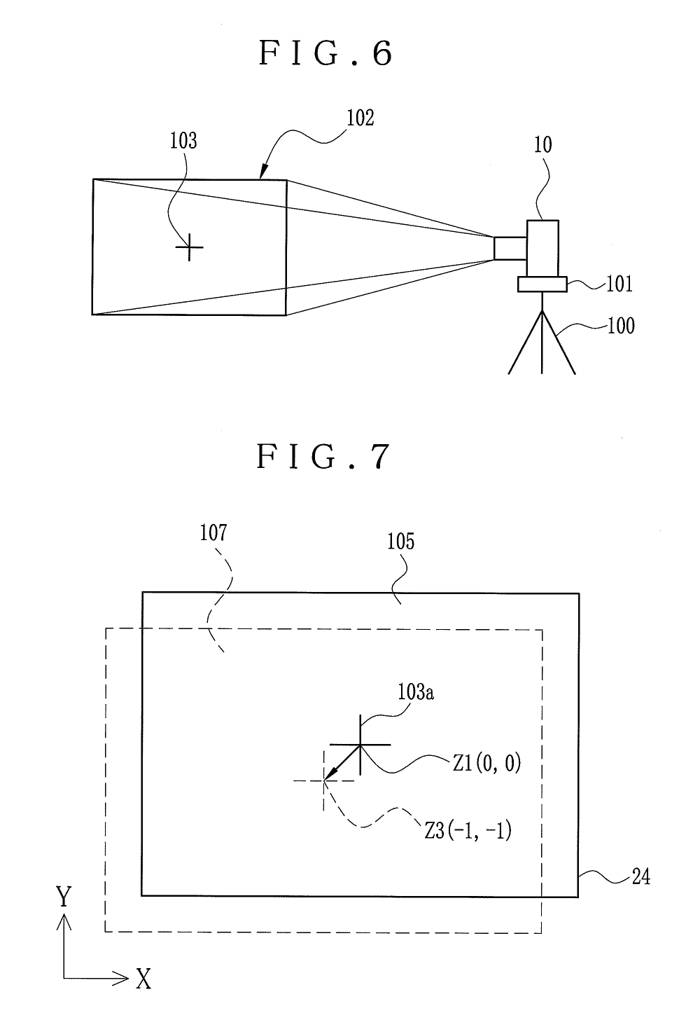

Measurement of a shift amount of an image frame according to zooming is described now. In FIG. 5, the digital still camera 10 in a final step in the manufacture is handled. A tripod 100 has a tripod head 101, on which the digital still camera 10 is secured as illustrated in FIG. 6. The digital still camera 10 is set stably at st1 without inclination in any of the yaw, pitch and roll directions.

A chart 102 on a plane surface is installed in front of the digital still camera 10, and oriented in a direction vertical to a floor surface. A cross shaped indicia 103 is printed at the center of the chart 102.

When the power switch 42 is depressed, the power source for the digital still camera 10 is turned on. The anti-vibration lens 56 is initially set at the mechanical center at st2. The center is referred to herein as a neutral position which is located on the optical axis OA. The zoom button 30 is depressed to set the lens system 14 at the telephoto end position ZP1 by changing the focal length at st3.

In FIG. 7, a live image 105 is displayed on the LCD display panel 24. A center of a cross shaped indicia 103a according to the cross shaped indicia 103 in the live image 105, namely the optical axis OA, is positioned at the center of the LCD display panel 24. A position of the digital still camera 10 is adjusted at st4 by moving the position of the tripod 100 or changing the height of the tripod head 101. Note that an indicia (not shown) for the center of the image frame is preferably indicated in the LCD display panel 24.

The shutter release button 40 is depressed fully to pick up an image of the chart 102 at st5. Image data of the chart 102 is written to the memory card 48. The CPU 58 acquires a center coordinate Z1 of the cross shaped indicia 103a according to the image data at st6. Then the zoom button 30 is depressed to set the lens system 14 at an intermediate position ZP2 between the telephoto and wide-angle end positions by changing the focal length at st7. The shutter release button 40 is depressed fully at st5. Then the CPU 58 acquires a center coordinate Z2 of the cross shaped indicia 103a according to the image data at st6.

Furthermore, the zoom button 30 is operated to set the lens system 14 at the wide-angle end position (ZP3) by changing the focal length at st7 and st8. The shutter release button 40 is depressed fully at st5. A live image 107 is indicated by the broken line in FIG. 7. According to obtained image data, the CPU 58 determines a center coordinate Z3 of the cross shaped indicia 103a at st6. Note that the calculation of the coordinates Z1-Z3 of the centers can be after the completion of image pickup of the chart 102.

Let an origin (0, 0) be the coordinate Z1 of the cross shaped indicia 103a according to the position ZP1. The coordiantes Z2 and Z3 of the cross shaped indicia 103a according to the positions ZP2 and ZP3 are determined as (−1, 0) and (−1, −1) by digitizing their differences from the origin (0, 0) at st9. See Table 1. For example, Z3 (−1, −1) expresses a point defined by a shift of −1 point in the yaw direction (X) from the origin (0, 0) and a shift of −1 point in the pitch direction (Y) from the origin (0, 0). Note that the term of one point is a predetermined unit distance with a minimum length.

TABLE 1

| ZP | ZX | ZY | Note |
|---|---|---|---|
| 1 | 0 | 0 | The origin (0, 0) is according |
| (TELEPHOTO) | | | to a position of image pickup |
| | | | as reference |
| 2 | −1 | 0 | A difference from the origin |
| | | | (0, 0) is digitized |
| 3 | −1 | −1 | A difference from the origin |
| (WIDE-ANGLE) | | | (0, 0) is digitized |

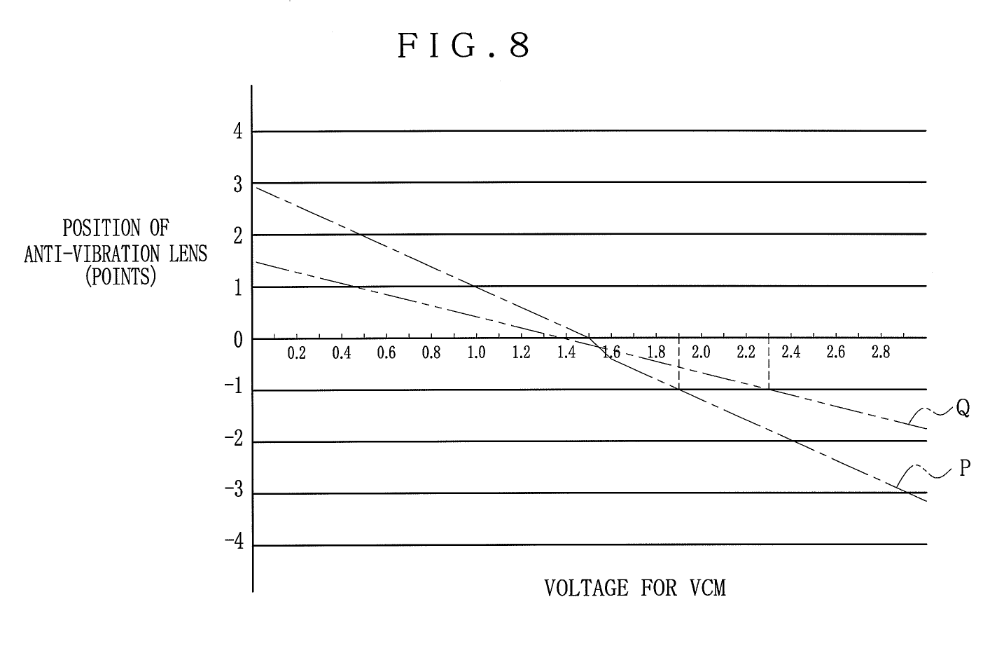

Voltage is applied to the H and V axis VCMs 88 and 89 in a range of 0.0-3.0 V with a stepwise increase of a step of 0.1 V. In FIG. 8, characteristic curves P and Q express changes in the shift amount of the anti-vibration lens 56 in the pitch and yaw directions. The coordinates of the points of the cross shaped indicia 103a, Z1 (0, 0), Z2 (−1, 0) and Z3 (−1, −1), according to the positions ZP1-ZP3 are converted into values of voltage for the H and V axis VCMs 88 and 89 by referring to FIG. 8 at st10. Results of the conversion are indicated in Table 2.

TABLE 2

| ZP | Yaw | Pitch |
|---|---|---|
| 1 (TELEPHOTO) | 1.4 V | 1.5 V |
| 2 | 2.3 V | 1.5 V |
| 3 (WIDE-ANGLE) | 2.3 V | 1.9 V |

The correlation in Table 2 between the focal length of the lens system 14 and the voltage for the H and V axis VCMs 88 and 89 is written to the flash memory 87 as a lookup table at st11.

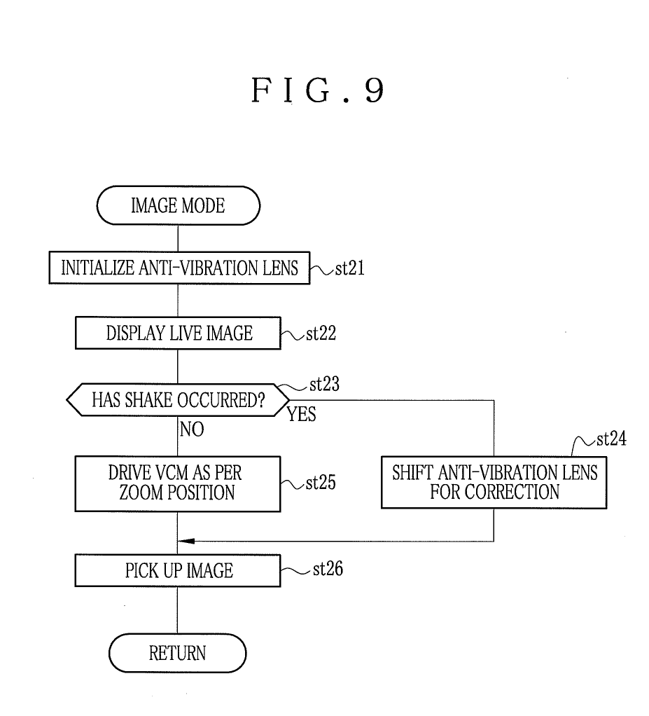

The operation of the digital still camera 10 is described by referring to a flow in FIG. 9. When the power source of the digital still camera 10 is turned on by operating the power switch 42, the CPU 58 loads the control program stored in the flash memory 87, and starts the control of the entirety of the digital still camera 10. An image mode is set initially as preset in the default operation. The anti-vibration lens 56 is set in the neutral position at st21. Then a live image is displayed on the LCD display panel 24 at st22.

When the yaw and pitch rate sensors 82 and 84 detect a camera shake at st23, the shake correction arithmetic unit 86 determines shift amounts of shake correction in the H and V directions according to angular velocity signals generated by the yaw and pitch rate sensors 82 and 84. The VCM control unit 96 drives the H and V axis VCMs 88 and 89 according to the data of the shift amounts of the shake correction to compensate for a camera shake at st24 by shifting the anti-vibration lens 56.

If the yaw and pitch rate sensors 82 and 84 do not detect a camera shake at st23, the CPU 58 refers to the lookup table in the flash memory 87, obtains voltage according to a zoom position of the variator lens/lens group 52, and applies the voltage to the H and V axis VCMs 88 and 89 at st25. Thus, framing can be easy because the center of a live image can be kept at the center of the LCD display panel 24 even the zoom button 30 is operated for zooming. Then the shutter release button 40 is depressed for image pickup. Image data is obtained and written to the memory card 48 at st26.

Accordingly, the center of a live image is kept at the center of the LCD display panel 24 even in zooming. This is effective in image pickup in a digital still camera, monitor camera, live camera for the fixed point, and the like. Although an image according to the feature of the invention is a live image in the above description, an image may be a recorded image or image frame.

Another preferred embodiment is described now. In general, a zoom lens system has lens aberration, for example, shading in which the light amount decreases toward corners of the image frame, and distortion in which fine deformation of an image increases toward the corners of the image frame. Lowering of the image quality due to the lens aberration is inconspicuous if the center of the image frame coincides with a position of a region with smallest influence of the lens aberration. However, this position of a region with smallest influence of the lens aberration shifts in response to zooming in the digital still camera of a zooming type. The problem is serious according to a specific one of zoom positions.

There is a face detection unit incorporated in the digital still camera for detecting a face of a person as principal object so that the principal object is focused in the digital still camera. However, a region of the principal object or a face being focused is likely to be different from a region within the image frame having high image quality. This results in low image quality of the entirety of the image frame according to appearance of an image due to the state of the focused region.

In JP-A 6-160693 and JP-A 7-027965, the change of the focal length in the lens system is changed over according to the rotational shift of the zoom ring and the rotational direction. It is impossible to solve the problem in the image shake at the time of zooming, lowering of the image quality due to influence of the lens aberration, and lowering of the image quality of the principal object. U.S. Pat. No. 6,785,426 (corresponding to JP-A 2001-223942) discloses image pickup of a region large in the horizontal direction. However, no suggestion of image pickup of a region large in the vertical direction is disclosed in the document.

In view of the technical background, the present embodiment is for correction in relation to the lens aberration of the lens system 14 by use of the anti-vibration lens 56. In the embodiment, shading is referred to specifically among various types of aberration including distortion, chromatic aberration and the like. Elements similar to those of the above embodiments are designated with identical reference numerals.

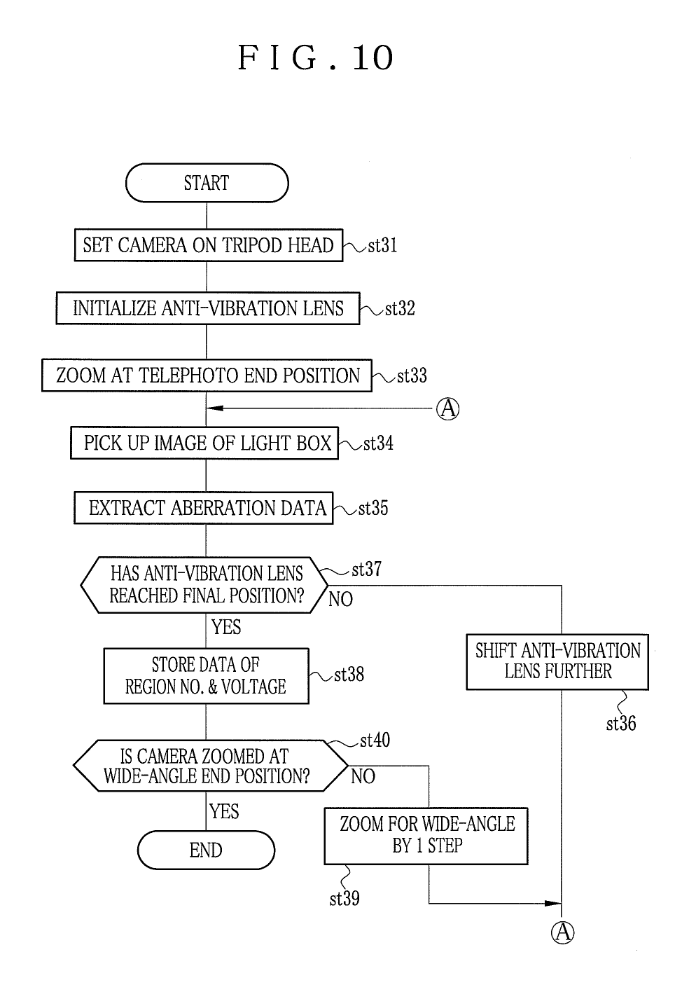

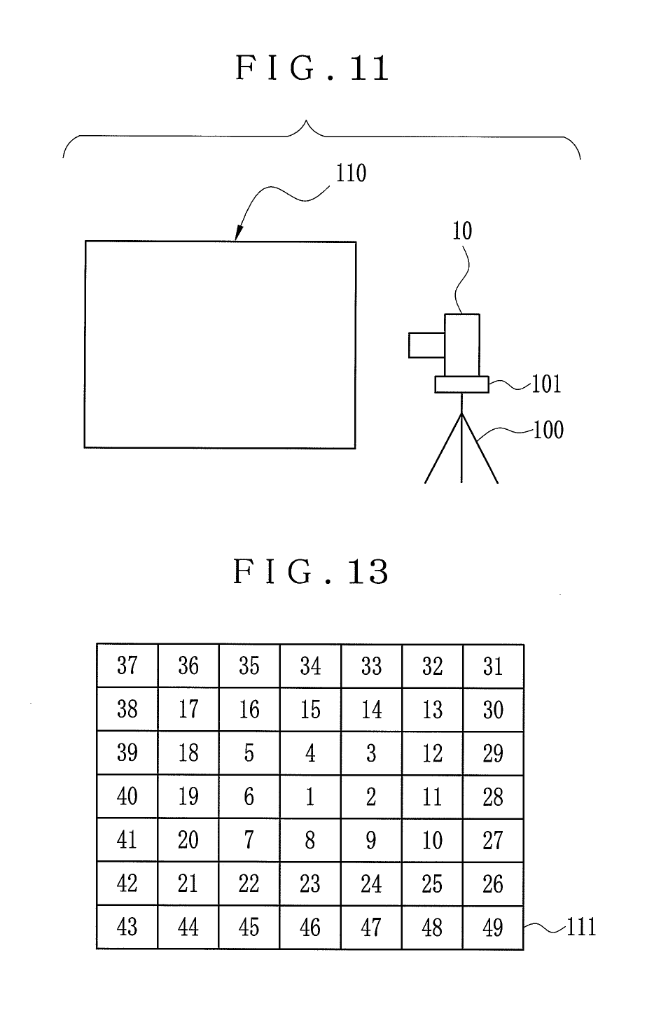

In FIG. 10, at first the digital still camera 10 is secured to the tripod head 101 of the tripod 100 at st31 in the manner the same as the above embodiment. In FIG. 11, a light box 110 with illumination is installed in front of the digital still camera 10. There is no unevenness in distribution of brightness.

The power switch 42 is depressed to turn on the digital still camera 10. The anti-vibration lens 56 is initially set in the neutral position at st32. The zoom button 30 is depressed to set the lens system 14 at the telephoto end position ZP1 by changing the focal length at st33.

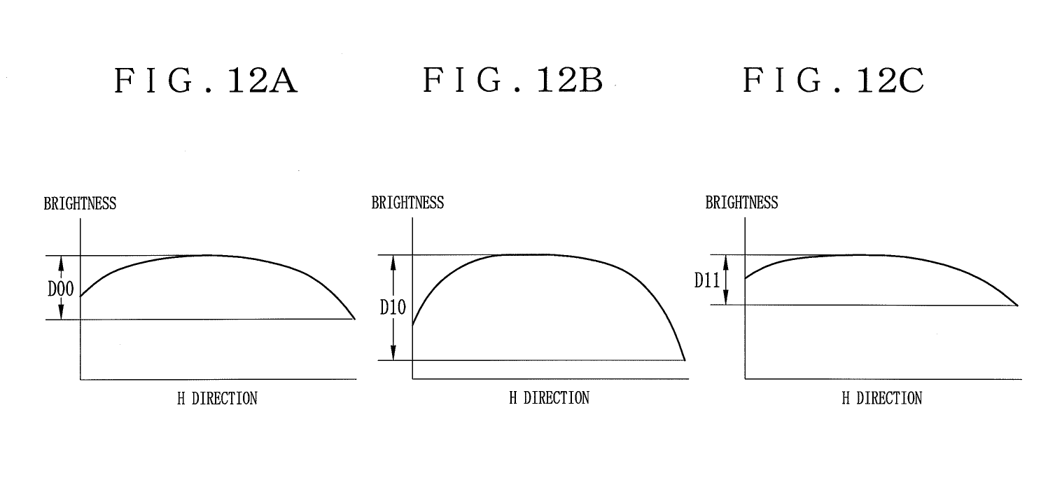

The shutter release button 40 is depressed fully to photograph the light box 110 at st34. Image data is obtained, and written to the memory card 48. At first, aberration data D00 is extracted from the image data at st35. In FIG. 12A, the aberration data D00 is according to a difference between the highest and lowest values of brightness in the brightness distribution of the image frame in the H direction. The aberration data D00 is data obtained when the center of the anti-vibration lens 56 is position at 0 point in the yaw direction and 0 point in the pitch direction.

In FIG. 13, a motion sequence chart 111 is illustrated. The anti-vibration lens 56 is successively shifted in a sequence from the neutral position at the center of a region 1, then to the center of a region 2, the center of a region 3, and so on in the manner of shifting on a spiral. At each time of shifting, an image is picked up in the light box 110. Should the anti-vibration lens 56 be shifted to the outermost region, the anti-vibration lens 56 will be very difficult to shift back to the neutral position adapted to correction of camera shake. Thus, the anti-vibration lens 56 is shifted no further than a region 9.

The center of the anti-vibration lens 56 is shifted and set at the center of the region 2 at st36. The light box 110 is photographed at st34 to extract aberration data D10. The aberration data D10 is data obtained when the center of the anti-vibration lens 56 is positioned with 1 point in the yaw direction and 0 point in the pitch direction. See FIG. 12B.

The center of the anti-vibration lens 56 is shifted to the center of the region 3 at st36. The light box 110 is picked up at st34 to extract aberration data D11. Note that the aberration data D11 is data at the time when the center of the anti-vibration lens 56 is positioned at 1 point in the yaw direction and 1 point in the pitch direction. This is indicated in FIG. 12C.

The anti-vibration lens 56 moves to the center position of the final region to complete the image pickup and the extraction of aberration data at st37. The number of one of the regions with the smallest aberration among the extracted sets of the aberration data is written to the flash memory 87 at st38. Also, data of voltage for application to the H and V axis VCMs 88 and 89 to move the anti-vibration lens 56 to the center of the region of the smallest aberration is written to the flash memory 87.

In the embodiment, the final region is the region 3. As is observed from FIGS. 12A-12C, the number of the region with the smallest aberration is 3. Voltage applied to the H axis VCM 88 is 0.5 V. Voltage applied to the V axis VCM 89 is 1.0 V. See FIG. 8.

Then the zoom button 30 is depressed to step the focal length of the lens system 14 by one step toward a wide-angle side at st39. A sequence from the step st34 to the step st38 is carried out. Also, the sequence from the step st34 to the step st38 is repeated at st40 until the lens system 14 comes to move to the wide-angle end position by changing the focal length.

Therefore, information of the region number and voltage applied to the H and V axis VCMs 88 and 89 is written to the flash memory 87 as aberration correction information, the region number being associated with a region of a smallest aberration, the voltage being so high as to shift the anti-vibration lens 56 to the center position of the region of the smallest aberration. Note that the aberration correction information to be stored may be only the voltage applied to the H and V axis VCMs 88 and 89.

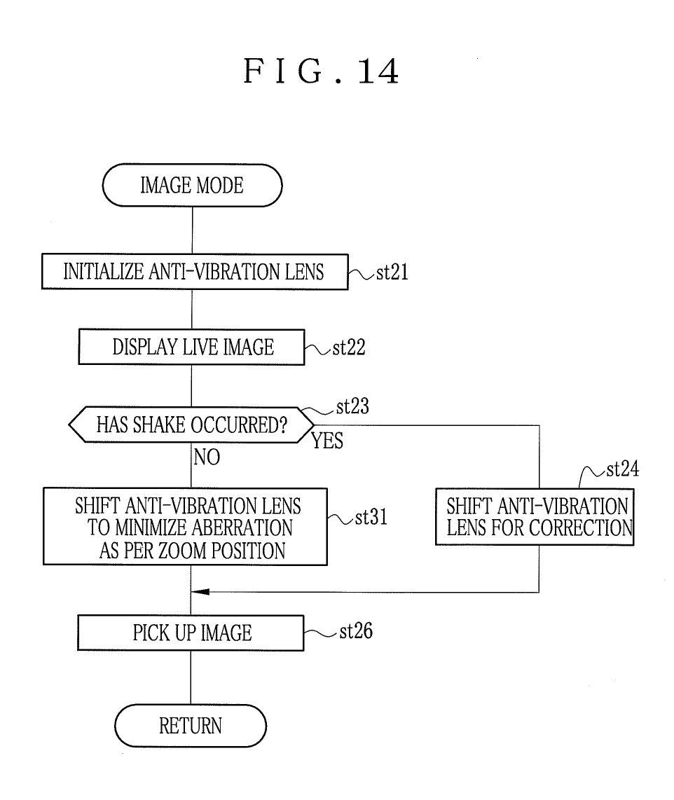

The operation of the present embodiment is described by referring to FIG. 14. If the yaw rate sensor 82 or the pitch rate sensor 84 does not detect a camera shake at st23, the CPU 58 refers to the aberration correction information for lens aberration stored in the flash memory 87. Voltage to minimize the lens aberration in the variator lens/lens group 52 set by zooming is applied to the H and V axis VCMs 88 and 89 at st31.

After this, the shutter release button 40 is depressed to pick up an image. Image data of an image with smallest lens aberration is written to the memory card 48 at st26.

Still another preferred embodiment is described now. In a digital still camera, a facial region in an object image is detected and automatically focused. If the facial region is located in the center region included in nine regions to split an image frame, image pickup is carried out simply. If the facial region is located in a peripheral region defined outside the center region among the nine regions, image pickup is carried out after moving the anti-vibration lens to set the facial region nearer to the center region which will result in higher image quality than the peripheral regions. It is possible automatically to pick up an image with high image quality of a facial region in addition to manual framing of a user.

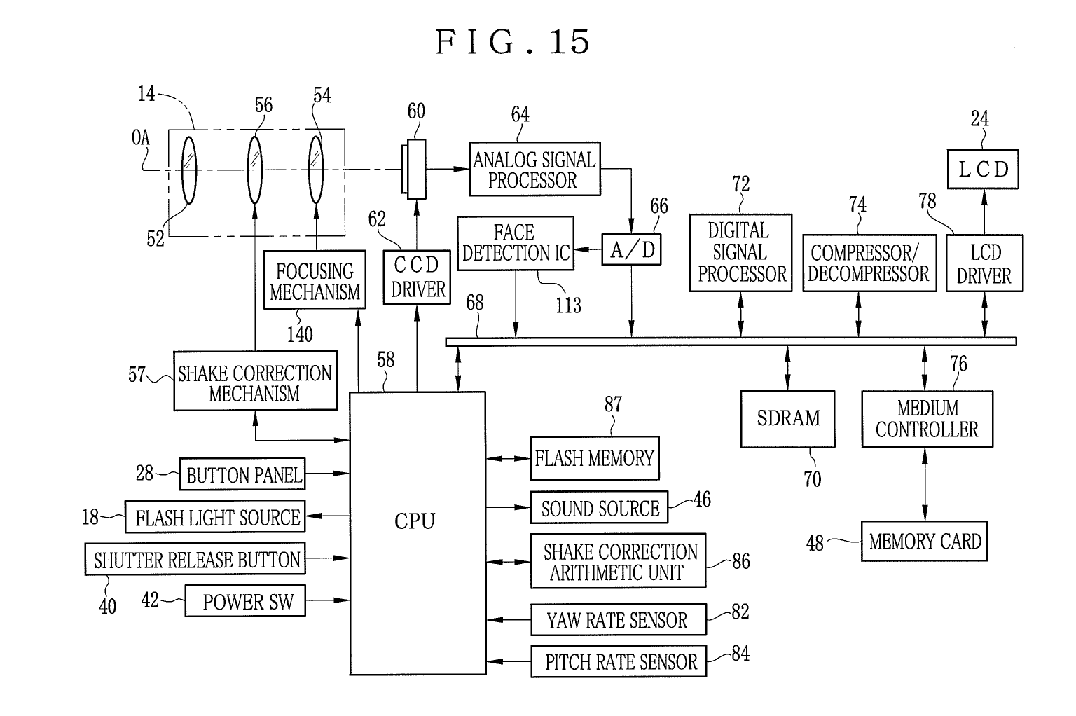

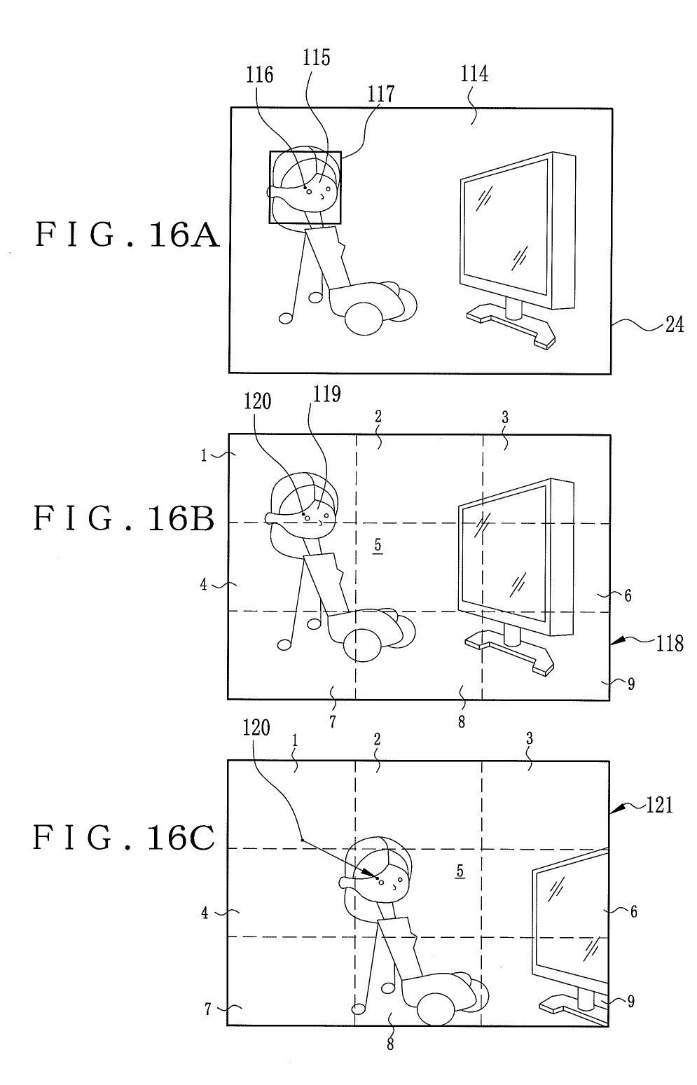

In FIG. 15, the embodiment is illustrated. The digital still camera 10 of the above embodiment is repeated with a difference of addition of a face detection IC 113. In FIG. 16A, the face detection IC 113 analyzes image data of a live image 114 or field image, and detects a face region 115 as object region. After this, the face detection IC 113 as a checker acquires a face center coordinate 116 as point in the face region 115.

For the face detection, a region in the live image 114 containing pixels of flesh color of a person according to its image data is extracted to detect the face region 115. To acquire the face center coordinate 116, a point equidistant from points on the contour line of the face region 115 is determined. Note that it is also possible to detect two eyes of the person and determine a middle point between the eyes as the face center coordinate 116. Furthermore, detection of a face or eyes may be based known techniques of image recognition.

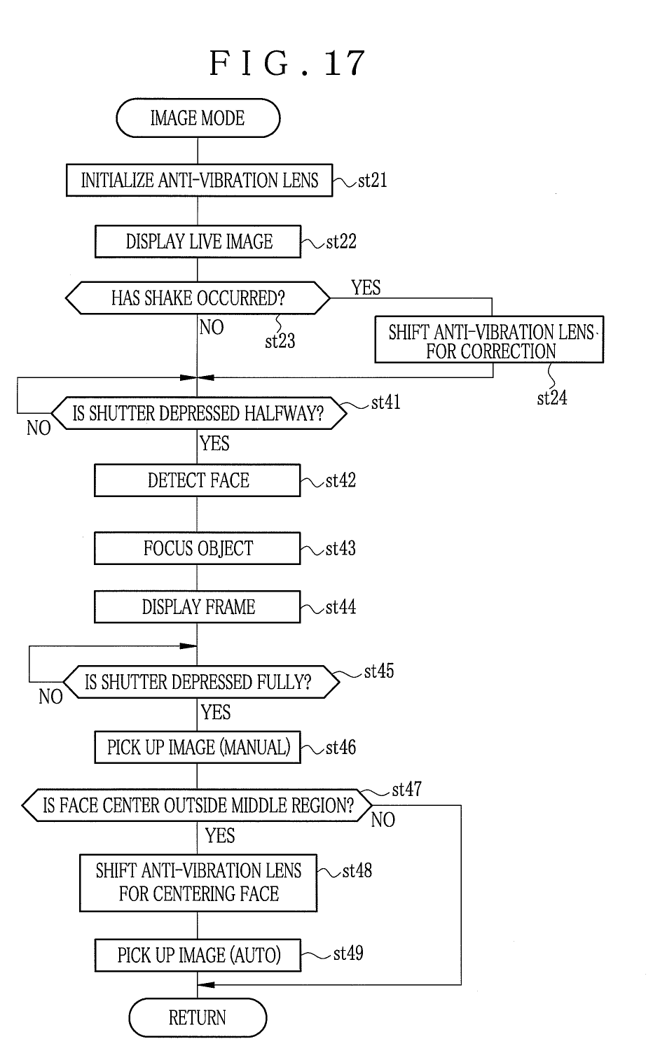

The sequence is described by referring to the flow in FIG. 17. The shutter release button 40 is depressed halfway at st41 without detection of a camera shake at st23. The face detection IC 113 detects the face region 115 at st42 according to image data of the live image 114 output by the image pickup unit 60, and also acquires the face center coordinate 116.

A focusing mechanism 140 is caused by the CPU 58 to move the focus lens/lens group 54 to focus the human face according to the face region 115 after the face detection at st43. A frame indicia 117 of a quadrilateral shape with a green color or the like is caused by the CPU 58 to appear on the LCD display panel 24 around the face region 115 at st44. The face region 115 is indicated in a clarified manner.

When the shutter release button 40 is depressed fully at st45, an image frame 118 is created at st46 as illustrated in FIG. 16B by framing in a manner similar to the live image 114. Then the face detection IC 113 determines a face region 119 as object region and a face center coordinate 120 as point according to the image frame 118.

If the face center coordinate 120 is not located in a region 5 among the nine split regions within the image frame 118 as indicated by the broken line, then the anti-vibration lens 56 is shifted at st48 to move the face center coordinate 120 as near to the region 5 as possible for high image quality. See FIG. 16C. A second image is picked up automatically at st49. Thus, an image frame 121 with priority to quality is obtained, in which the face region 119 is focused and recorded with high quality in addition to the image frame 118 in an originally framed manner.

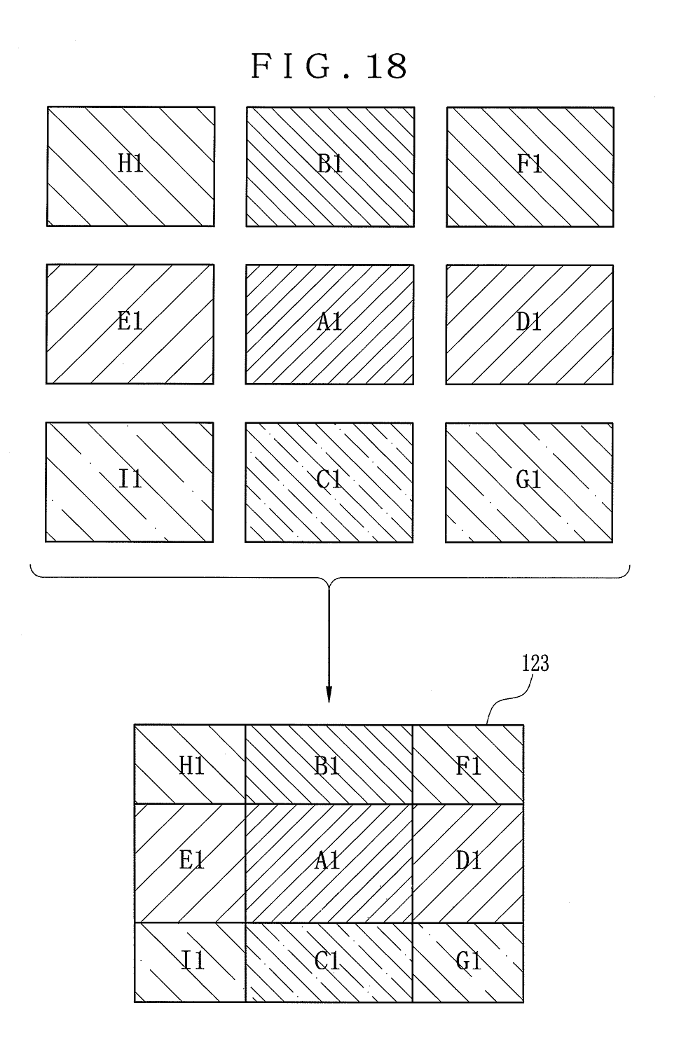

Another preferred embodiment is described now. In FIG. 18, a composite image 123 is created. At first, a user picks up an image A1 by his or her own framing, before the anti-vibration lens 56 is automatically shifted up and down for images B1 and C1, to the right and left for images D1 and E1, to the upper right side for an image F1, to the lower right side for an image G1, to the upper left side for an image H1, and to the lower left side for an image I1. One image is picked up for each one time of shifting. The obtained nine images A1-I1 are combined to obtain the composite image 123.

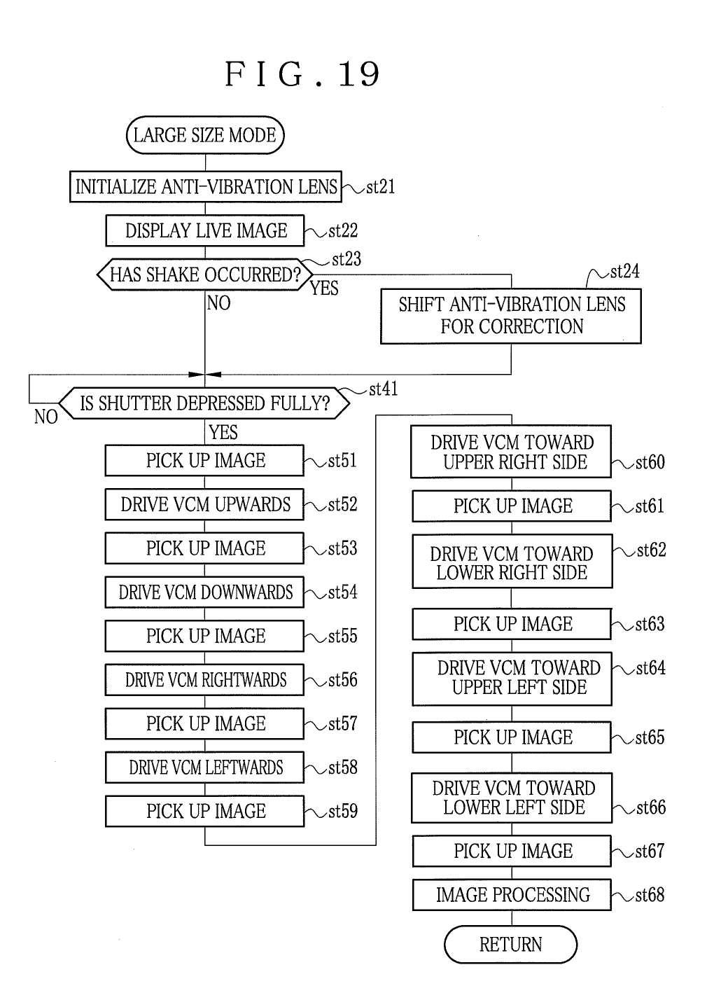

In FIG. 19, a flow of the embodiment is illustrated. The mode button 38 is operated to set a large size mode of image pickup. The shutter release button 40 is fully depressed at st41 without detection of a camera shake (st23). An image is picked up while the anti-vibration lens 56 is set in the neutral position. An image A1 is formed.

After this, the VCM control unit 96 as consecutive imaging unit (FIG. 4) applies a predetermined voltage to the V axis VCM 89 without powering the H axis VCM 88. The anti-vibration lens 56 is shifted exactly upwards at the maximum distance in its shiftable region at st52. An image B1 is picked up at st53 in a manner to record a larger area on the upper side than in the image A1. Note that a direction of a shift of an image to be picked up coincides with a direction of shifting the anti-vibration lens 56. The maximum distance of the shiftable region of the anti-vibration lens 56 is constant and predetermined for each of the plural distances of shifting.

After picking up the image B1, powering to the V axis VCM 89 is discontinued, to shift back the anti-vibration lens 56 in the neutral position. A predetermined voltage is applied to the V axis VCM 89 without powering the H axis VCM 88, to shift the anti-vibration lens 56 down at st54 by a maximum distance in a shiftable region. An image C1 is picked up to record a larger area on the lower side than the image A1 at st55.

After the image C1 is picked up, powering of the V axis VCM 89 is discontinued. The anti-vibration lens 56 is shifted back in the neutral position by resetting. Then a predetermined voltage is applied to the H axis VCM 88 without powering the V axis VCM 89, to shift the anti-vibration lens 56 to the right side by a maximum distance in a shiftable region at st56. An image D1 is picked up at st57 to record a larger area located on the right than the image A1.

After the image D1 is picked up, powering of the H axis VCM 88 is discontinued. The anti-vibration lens 56 is shifted back in the neutral position by resetting. Then a predetermined voltage is applied to the H axis VCM 88 without powering the V axis VCM 89, to shift the anti-vibration lens 56 to the left side by a maximum distance in a shiftable region at st58. An image E1 is picked up at st59 to record a larger area located on the left than the image A1.

After the image E1 is picked up, powering of the H axis VCM 88 is discontinued. The anti-vibration lens 56 is shifted back to its neutral position. Predetermined voltage is applied to each of the H and V axis VCMs 88 and 89 to shift the anti-vibration lens 56 to the upper right side at the maximum distance in the shiftable region at st60. An image F1 is picked up at st61 to record a larger area on the upper right side than the image A1.

After forming the image F1, powering to the H and V axis VCMs 88 and 89 is discontinued, to set the anti-vibration lens 56 back to the neutral position. Then a predetermined voltage is applied to each of the H and V axis VCMs 88 and 89 to shift the anti-vibration lens 56 to the lower right side by a maximum distance in its shiftable region at st62. An image G1 is picked up to record a larger area on the lower right side than the image A1 at st63.

After forming the image G1, powering to the H and V axis VCMs 88 and 89 is discontinued, to set the anti-vibration lens 56 back to the neutral position. Then a predetermined voltage is applied to each of the H and V axis VCMs 88 and 89 to shift the anti-vibration lens 56 to the upper left side by a maximum distance in its shiftable region at st64. An image H1 is picked up to record a larger area on the upper left side than the image A1 at st65.

After forming the image H1, powering to the H and V axis VCMs 88 and 89 is discontinued, to set the anti-vibration lens 56 back to the neutral position. Then a predetermined voltage is applied to each of the H and V axis VCMs 88 and 89 to shift the anti-vibration lens 56 to the lower left side by a maximum distance in its shiftable region at st66. An image I1 is picked up to record a larger area on the lower left side than the image A1 at st67.

Image data of images A1-I1 are written to the SDRAM 70 after each time of image pickup. Those, when written to the SDRAM 70, are read and edited by the CPU 58 as image synthesis unit and combined for synthesis. Image data of one large size image is created by the synthesis, and written to the memory card 48 at st68. It is possible to form an image of a great angle of view without distortion, although serious distortion would occur if a super wide-angle lens of a well-known type is used to take an image of the same great angle of view.

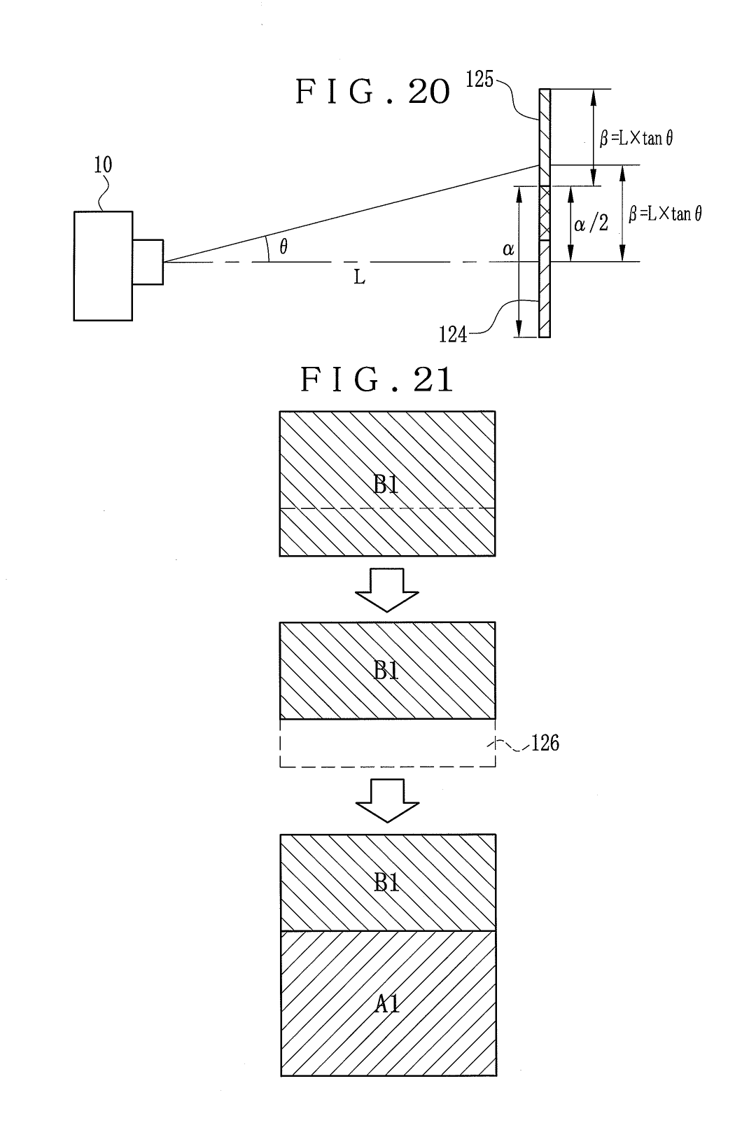

Image synthesis at st68 is described now. In FIG. 20, an image frame region 124 is combined with an image frame region 125. Image data of the image frame region 124 corresponds to the image A1, and is formed while the anti-vibration lens 56 is set in the neutral position. Image data of the image frame region 125 corresponds to the image B1 and is formed while the optical axis OA is tilted by the angle θ by shifting the anti-vibration lens 56 upward in the pitch direction by the maximum distance of a shiftable region.

The width a of the image frame region 124 in the vertical direction is obtained according to the subject distance L and the angle of view of the image pickup. Thus, a distance α/2 from the center of the image frame region 124 to its end is determined. A distance β from the center of the image frame region 124 to the center of the image frame region 125 is determined as L×tan θ. As is observed in the drawing, a distance between upper ends of the image frame regions 124 and 125 is the distance β equal to the distance β between the centers of the image frame regions 124 and 125, and is obtained as L×tan θ.

Image data of the images A1 and B1 are synthesized. In FIG. 21, an overlapped portion 126 is indicated, which is defined to lie in both of images A1 and B1 derived by photographing the image frame regions 124 and 125. In the synthesis, an upper edge of the image A1 is set along a lower edge of a partial region of the image B1 defined by eliminating the overlapped portion 126. In a similar manner, the images A1-I1 are processed in the image synthesis, so that the composite image 123 is formed finally.

In the process of the synthesis, the shift amount of the anti-vibration lens 56 is the maximum distance in the shiftable region in each of the plural directions, and is constant for each direction (θ is constant). Thus, portions of the overlap of the images B1-I1 on the image A1 are previously known. The overlapping portions are cut away from the images B1-I1 before those are synthesized with the image A1 by the partial use. This is effective in reducing time for arithmetic processing of the synthesis in comparison with the pattern matching processing. The composite image 123 can be obtained only after a short time.

The image A1 of its original form is used in the synthesis, as the image A1 is formed without shifting the 56 and has small shading and small distortion. The synthesis according to the embodiment is effective in obtaining high image quality without much degradation. Note that pattern matching may be used for finish of the image synthesis.

Still another preferred embodiment is described now. In contrast with the fourth embodiment where the anti-vibration lens 56 is shifted in the various directions, the anti-vibration lens 56 is shiftable in a limited shiftable region. Images B2-E2 with shifts in various directions are picked up with an overlap of ⅓ of the frame size on the image A2 with reference to the center of the image A2 picked up by setting the anti-vibration lens 56 in the neutral position. Note that the shift amount of the anti-vibration lens 56 is set constant between various directions of shift.

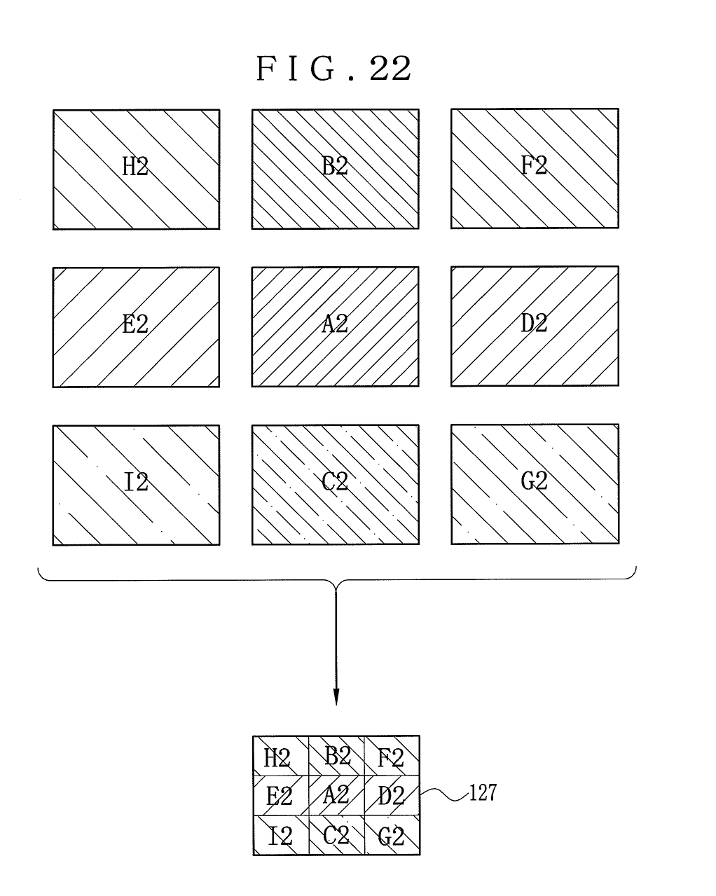

Images F2, G2, H2 and I2 are picked up in an overlapped manner on the image A2 with an area of 1/9 at the corners. Each one of the images A2-I2 are split into nine regions. Middle portions of the nine regions are used and combined for image synthesis. The middle portions do not have much shading, distortion or other aberration. In FIG. 22, a composite image 127 with high quality is obtained, from which influence of aberration are completely removed. Note that a size of the composite image 127 is equal to that of the image A2 before the synthesis.

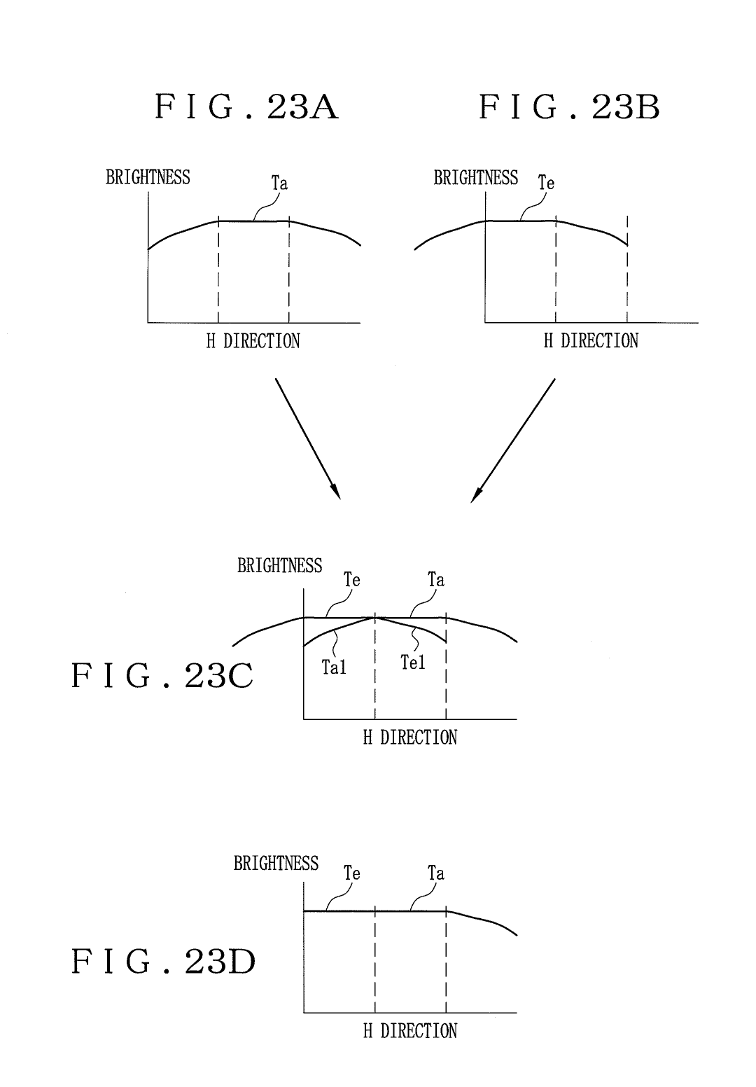

The synthesis of the embodiment is described by referring to FIGS. 23A-23D. In particular, a combination of the images A2 and E2 is referred to now. In FIG. 23A, a characteristic curve Ta expresses a characteristic of shading of the image A2 in the H direction, the image A2 being obtained by picking up a flat board uniformly colored with white color. In FIG. 23B, a characteristic curve Te expresses a characteristic of shading of the image E2 in the H direction, the image E2 being obtained by picking up the same white board.

The characteristic curves Ta and Te are split into three sections in the H direction. In the center region of the images A2 and E2, the brightness is constant. No considerable shading is found. In the section of one third of the images A2 and E2 on the right side and the section of one third of the images A2 and E2 on the left side, the brightness decreases in the direction toward the end. Degree of shading also increases.

In FIG. 23C, a state of synthesizing the characteristic curves Ta and Te is illustrated with an overlap of ⅓. Portions Ta1 and Te1 with the overlap of the images A1 and E1 are removed so as to obtain an image without shading, which is illustrated in FIG. 23D. In this manner, the image A2 is synthesized with the images B2-I2 by the partial use. The composite image 127 after completely eliminating shading can be obtained. See FIG. 22.

Influence of shading or other aberration is completely eliminated from the composite image 127. The composite image 127 is suitable for use in location survey of an object. For this purpose, the digital still camera 10 is fastened on the tripod head 101 of the tripod 100 as illustrated in FIG. 6. The digital still camera 10 is kept set without tilting in any of the yaw, pitch and roll directions. An image of an object to be measured by the digital still camera 10 is picked up according to the fifth embodiment. A composite image 129 as illustrated in FIGS. 25A-25D can be obtained, from which influence of aberration has been completely eliminated.

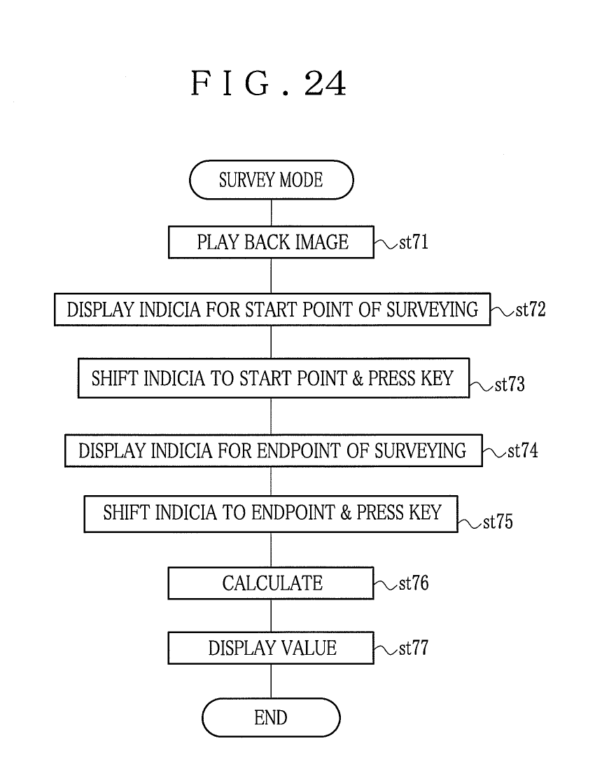

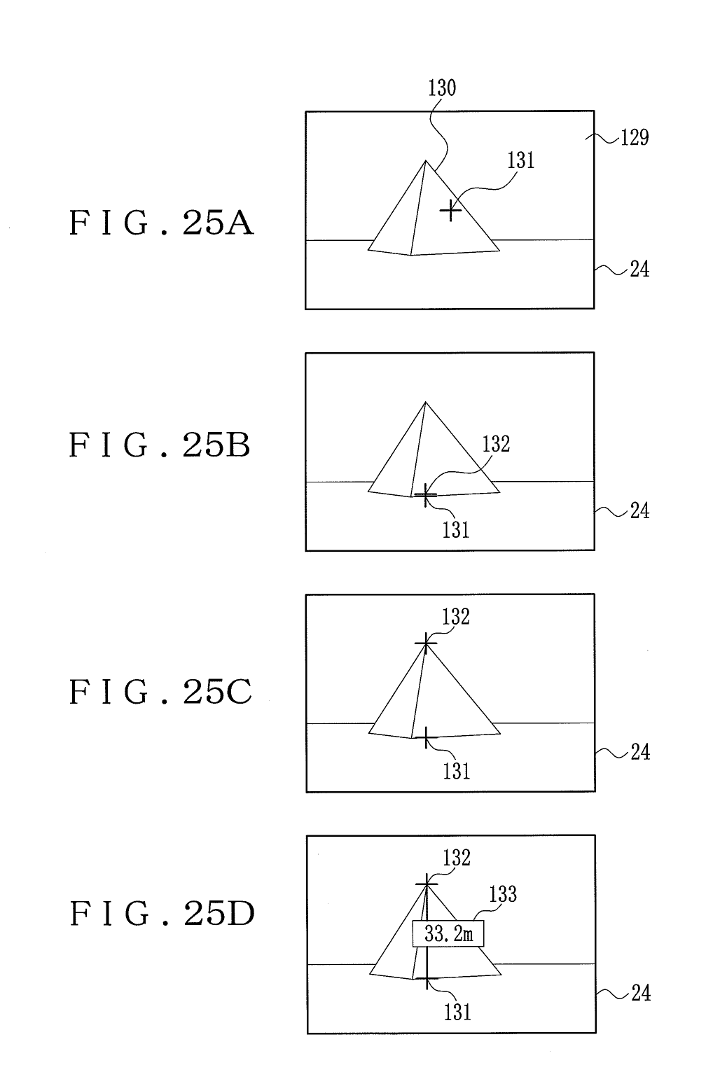

The location survey mode is set in the digital still camera 10 by operating the mode button 38. In FIG. 24, the composite image 129 is displayed on the LCD display panel 24 by playback at st71. A pyramid as image of a principal object 130 appears in the composite image 129 as an object of location survey. A survey start point 131 of a cross shape is displayed on the LCD display panel 24 at st72.

The cross shaped key 36 is depressed to shift the survey start point 131 according to user preference, for example, to a boundary of the principal object 130 on the ground. The confirmation key 37 is depressed, to fix the indicia of the survey start point 131 at st73. A survey endpoint 132 in the shape similar to that of the survey start point 131 is simultaneously indicated near to the survey start point 131 at st74.

The survey endpoint 132 is movable only in a direction defined with 90 degrees from the indicia of the survey start point 131, namely vertically or horizontally on the surface of the LCD display panel 24. The survey endpoint 132 is shifted up from the survey start point 131 by operating the cross shaped key 36, and is set at the top of the principal object 130. Then a user depresses the confirmation key 37 to keep the survey endpoint 132 set for the end of the location survey. See the step st75.

The CPU 58 determines a distance from the survey start point 131 to the survey endpoint 132 on the display surface according to their coordinates. An exact height of the pyramid is determined according to the range finding information and a focal length of the lens system 14 at st76, for example 33.2 meters. The value of 33.2 meters is indicated in a window region 133 on the LCD display panel 24 at st77.

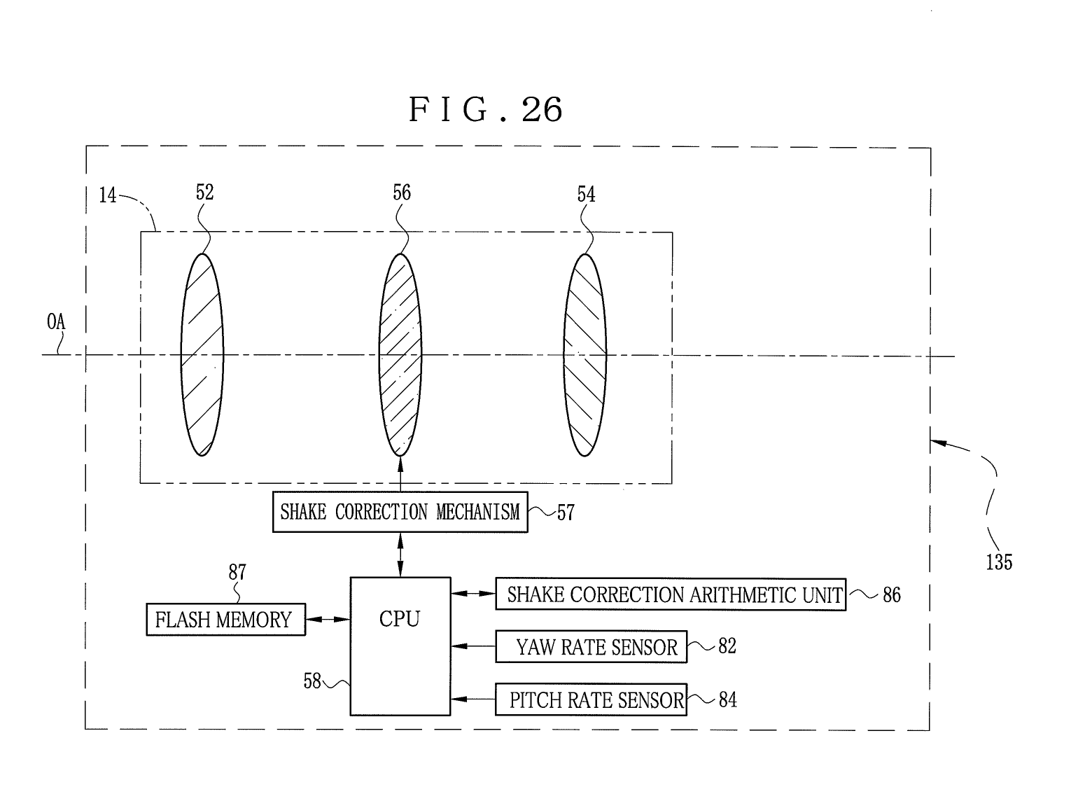

Another preferred lens unit 135 is described now. In FIG. 26, the lens unit 135 includes the lens system 14, the shake correction mechanism 57 of FIG. 4, the CPU 58, the yaw rate sensor 82, the pitch rate sensor 84, the shake correction arithmetic unit 86 and the flash memory 87.

The flash memory 87 stores a lookup table (LUT) and a control program in relation to image shake in a manner similar to the first embodiment. It is possible only in the lens unit 135 to correct a camera shake and an image shake at the time of zooming of the lens system 14. The lens unit 135 is mounted removably on a camera body of a digital still camera of a single lens reflex type (SLR). Also, the lens unit 135 can be constructed in a super micro type, and can be incorporated in a digital still camera of a compact type or camera built-in cellular telephone.

Also, it is possible to store aberration correction information for aberration in the flash memory 87 of the lens unit 135 in the same manner as the second embodiment. The lens aberration created in zooming the lens system 14 can be compensated for.

Note that the lens unit 135 may accommodate the image pickup unit or CCD image sensor in its rear portion and may send image data to a camera body on which the lens unit 135 is mounted. Furthermore, a camera body may accommodate the image pickup unit or CCD image sensor, on which an image is focused by the lens unit 135 which is positioned in front of the image pickup unit of the camera body.

In the first embodiment, the zoom positions of the zoom lens are the telephoto end position, intermediate position, and wide-angle end position. A shift amount of an image is measured in the three zoom positions. However, the number of the zoom positions may be four or more, for example, five. A shift amount of an image can be measured in the five zoom positions. Precision in correcting the shift can be higher according to highness in the number of the zoom positions. Furthermore, zoom positions may be 10 positions, and a shift amount of an image can be measured only in three of 10 zoom positions. For the remaining seven zoom positions, a shift amount can be determined by estimation according to the shift amount derived from the three zoom positions by suitable methods, such as interpolation or the like.

In the third embodiment, an original image after framing in the manual operation is recorded in addition to the corrected image with priority to quality. However, it is possible to record only a corrected image with priority to quality.

In the fifth embodiment, the center region included in the nine split regions is used in the image synthesis. However, a center region may be a region larger than a one ninth area of the entire image frame, and may be formed by splitting away four edge portions along the peripheral lines of the image frame. At this time of image synthesis, an obtained image comes to have a size larger than the initial image.

In the fourth and fifth embodiments, a composite image is obtained by combining partial images of the nine split regions. However, the number of the split regions which are arranged in a matrix form may be other numbers different from nine.

In the above five embodiments, angular velocity sensors of the yaw and pitch directions are incorporated in the camera body. However, the angular velocity sensors of the yaw and pitch directions may be disposed inside the lens barrel, or outside the lens barrel.

In the above five embodiments, the anti-vibration lens is used for shake correction or image stabilization. However, it is possible to shift the image pickup unit or CCD image sensor in a direction on a plane perpendicular to the optical axis OA. In the third, fourth and fifth embodiments, the lens system may be a lens of a fixed focus as type different from a zoom lens.

In the embodiments, the camera is the digital still camera. However, an image pickup apparatus of the invention may be a camera built-in cellular telephone, digital video camera for motion picture, and other apparatuses for image taking.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. An image pickup apparatus comprising:
a lens system having a variable focal length;
an image pickup unit disposed on an optical axis of said lens system, for image pickup of an image frame;
a shake detector for detecting a camera shake to output shake information;
an anti-vibration element for shake correction of said camera shake;
a shake correction mechanism for driving to shift said anti-vibration element on a plane perpendicular to said optical axis;
a memory for storing information of a shift amount of said anti-vibration element in correlation with said focal length, to compensate for an image shake in said image frame due to a change in said focal length; and
a controller for controlling said shake correction mechanism according to said shake information to compensate for said camera shake, and for, in case of lack of compensation for said camera shake, controlling said shake correction mechanism according to said information read from said memory to compensate for said image shake.

2. An image pickup apparatus as defined in claim 1, wherein said anti-vibration element is a selected one of an anti-vibration lens included in said lens system and said image pickup unit.

3. An image pickup apparatus comprising:
a lens system having a variable focal length;
an image pickup unit disposed on an optical axis of said lens system, for image pickup of an image frame;
a shake detector for detecting a camera shake to output shake information;
an anti-vibration element for shake correction of said camera shake;
a shake correction mechanism for driving to shift said anti-vibration element on a plane perpendicular to said optical axis;
a memory for storing position information of said anti-vibration element in correlation with said focal length, to minimize influence of lens aberration changeable according to a change in said focal length; and
a controller for controlling said shake correction mechanism according to said shake information to compensate for said camera shake, and for, in case of lack of compensation for said camera shake, controlling said shake correction mechanism according to said information read from said memory, to minimize influence of said lens aberration.

4. An image pickup apparatus as defined in claim 3, wherein said anti-vibration element is a selected one of an anti-vibration lens included in said lens system and said image pickup unit.

5. An image pickup apparatus comprising:
a lens system having a variable focal length;
an image pickup unit disposed on an optical axis of said lens system, for image pickup of an image frame;
a shake detector for detecting a camera shake to output shake information;
an anti-vibration element for shake correction of said camera shake;
a shake correction mechanism for driving to shift said anti-vibration element on a plane perpendicular to said optical axis;
an object detection unit for detecting an object region of a principal object in said image frame;
a checker for determining a position of said principal object in said image frame; and
a controller for controlling said shake correction mechanism according to said shake information to compensate for said camera shake, and for, in case of lack of compensation for said camera shake, controlling said shake correction mechanism according to said position of said principal object to set said object region nearer to a middle of said image frame.

6. An image pickup apparatus as defined in claim 5, wherein said anti-vibration element is a selected one of an anti-vibration lens included in said lens system and said image pickup unit.

7. An image pickup apparatus comprising:
a lens system having a variable focal length;
an image pickup unit disposed on an optical axis of said lens system, for image pickup of an image frame;
a shake detector for detecting a camera shake to output shake information;
an anti-vibration element for shake correction of said camera shake;
a shake correction mechanism for driving to shift said anti-vibration element on a plane perpendicular to said optical axis;
a controller for controlling said shake correction mechanism according to said shake information to compensate for said camera shake, and for, in case of lack of compensation for said camera shake, driving said image pickup unit in controlling said shake correction mechanism to shift said anti-vibration element two-dimensionally in order to form plural image frames consecutively; and
an image synthesis unit for obtaining a composite image frame in a larger size than said image frame by image synthesis of said plural image frames.

8. An image pickup apparatus as defined in claim 7, wherein said image synthesis unit combines middle portions of said plural image frames to obtain said composite image frame.

9. An image pickup apparatus as defined in claim 7, wherein said anti-vibration element shifts on an orbit in a quadrilateral shape defined around a center at said optical axis in consecutive imaging.

10. An image pickup apparatus as defined in claim 7, wherein said anti-vibration element is a selected one of an anti-vibration lens included in said lens system and said image pickup unit.

11. A lens unit comprising:
a lens system having a variable focal length;
a shake detector for detecting a camera shake to output shake information;
an anti-vibration element for shake correction of said camera shake;
a shake correction mechanism for driving to shift said anti-vibration element on a plane perpendicular to an optical axis of said lens system;
a memory for storing information of a shift amount of said anti-vibration element in correlation with said focal length, to compensate for an image shake in said image frame due to a change in said focal length; and
a controller for controlling said shake correction mechanism according to said shake information to compensate for said camera shake, and for, in case of lack of compensation for said camera shake, controlling said shake correction mechanism according to said information read from said memory to compensate for said image shake.

12. A lens unit comprising:
a lens system having a variable focal length;
a shake detector for detecting a camera shake to output shake information;
an anti-vibration element for shake correction of said camera shake;
a shake correction mechanism for driving to shift said anti-vibration element on a plane perpendicular to an optical axis of said lens system;
a memory for storing position information of said anti-vibration element in correlation with said focal length, to minimize influence of lens aberration changeable according to a change in said focal length; and
a controller for controlling said shake correction mechanism according to said shake information to compensate for said camera shake, and for, in case of lack of compensation for said camera shake, controlling said shake correction mechanism according to said information read from said memory, to minimize influence of said lens aberration.

13. An image pickup method of image pickup of an image frame with an image pickup unit through a lens system having a variable focal length, comprising steps of:
outputting shake information from a shake detector when a camera shake is detected;
shifting an anti-vibration element on a plane perpendicular to an optical axis of said lens system according to said shake information, to compensate for said camera shake;
in case of lack of compensation for said camera shake, reading information of a shift amount of said anti-vibration element from a memory, said information being in correlation with said focal length to compensate for an image shake in said image frame due to a change in said focal length; and
shifting said anti-vibration element according to said information read from said memory, to compensate for said image shake.

14. An image pickup method of image pickup of an image frame with an image pickup unit through a lens system having a variable focal length, comprising steps of:
outputting shake information from a shake detector when a camera shake is detected;
shifting an anti-vibration element on a plane perpendicular to an optical axis of said lens system according to said shake information, to compensate for said camera shake;
in case of lack of compensation for said camera shake, reading position information of said anti-vibration element from a memory, said information being in correlation with said focal length for minimizing influence of lens aberration changeable according to a change in said focal length; and
shifting said anti-vibration element according to said information read from said memory, to minimize influence of said lens aberration.

15. An image pickup method of image pickup of an image frame with an image pickup unit through a lens system having a variable focal length, comprising steps of:
outputting shake information from a shake detector when a camera shake is detected;
shifting an anti-vibration element on a plane perpendicular to an optical axis of said lens system according to said shake information, to compensate for said camera shake;
detecting an object region of a principal object in said image frame;
determining a position of said principal object in said image frame; and
in case of lack of compensation for said camera shake, shifting said anti-vibration element according to said position of said principal object to set said object region nearer to a middle of said image frame.

16. An image pickup method of image pickup of an image frame with an image pickup unit through a lens system having a variable focal length, comprising steps of:
outputting shake information from a shake detector when a camera shake is detected;
shifting an anti-vibration element on a plane perpendicular to an optical axis of said lens system according to said shake information, to compensate for said camera shake;
in case of lack of compensation for said camera shake, driving said image pickup unit in shifting said anti-vibration element two-dimensionally in order to form plural image frames consecutively; and
obtaining a composite image frame in a larger size than said image frame by image synthesis of said plural image frames.

17. An image pickup method as defined in claim 16, wherein middle portions of said plural image frames are combined to obtain said composite image frame.

18. A computer executable program for control of image pickup of an image frame with an image pickup unit through a lens system having a variable focal length, comprising:
a program code for outputting shake information from a shake detector when a camera shake is detected;
a program code for shifting an anti-vibration element on a plane perpendicular to an optical axis of said lens system according to said shake information, to compensate for said camera shake;
a program code for, in case of lack of compensation for said camera shake, reading information of a shift amount of said anti-vibration element from a memory, said information being in correlation with said focal length to compensate for an image shake in said image frame due to a change in said focal length; and
a program code for shifting said anti-vibration element according to said information read from said memory, to compensate for said image shake.

19. A computer executable program for control of image pickup of an image frame with an image pickup unit through a lens system having a variable focal length, comprising:
a program code for outputting shake information from a shake detector when a camera shake is detected;
a program code for shifting an anti-vibration element on a plane perpendicular to an optical axis of said lens system according to said shake information, to compensate for said camera shake;
a program code for, in case of lack of compensation for said camera shake, reading position information of said anti-vibration element from a memory, said information being in correlation with said focal length for minimizing influence of lens aberration changeable according to a change in said focal length; and
a program code for shifting said anti-vibration element according to said information read from said memory, to minimize influence of said lens aberration.

20. A computer executable program for control of image pickup of an image frame with an image pickup unit through a lens system having a variable focal length, comprising:
a program code for outputting shake information from a shake detector when a camera shake is detected;
a program code for shifting an anti-vibration element on a plane perpendicular to an optical axis of said lens system according to said shake information, to compensate for said camera shake;
a program code for detecting an object region of a principal object in said image frame;
a program code for determining a position of said principal object in said image frame; and
a program code for, in case of lack of compensation for said camera shake, shifting said anti-vibration element according to said position of said principal object to set said object region nearer to a middle of said image frame.

21. A computer executable program for control of image pickup of an image frame with an image pickup unit through a lens system having a variable focal length, comprising:
a program code for outputting shake information from a shake detector when a camera shake is detected;
a program code for shifting an anti-vibration element on a plane perpendicular to an optical axis of said lens system according to said shake information, to compensate for said camera shake;
a program code for, in case of lack of compensation for said camera shake, driving said image pickup unit in shifting said anti-vibration element two-dimensionally in order to form plural image frames consecutively; and
a program code for obtaining a composite image frame in a larger size than said image frame by image synthesis of said plural image frames.
